(19) United States
(12) Patent Application Publication
(10) Pub. No.: US 2011/0129270 A1
(43) Pub. Date: Jun. 2, 2011

(54) PROTECTIVE SHEET, IMAGE FORMING METHOD, AND IMAGE FORMING APPARATUS

(76) Inventors: Kumiko Seo, Kanagawa (JP); Toshiyuki Kabata, Kanagawa (JP); Hiroshi Nakai, Kanagawa (JP)

(21) Appl. No.: 12/955,452

(22) Filed: Nov. 29, 2010

(30) Foreign Application Priority Data
Dec. 1, 2009 (JP) 2009-273379
Mar. 4, 2010 (JP) 2010-047571
Nov. 4, 2010 (JP) 2010-247167
Nov. 8, 2010 (JP) 2010-249835

(51) Int. Cl. G03G 21/00; F16N 99/00

(52) U.S. Cl. 399/346; 184/102

(57) ABSTRACT

A protective sheet including a lubricant which contains boron nitride and adheres to the protective sheet, wherein the protective sheet is used to protect a photoconductor.

### BACKGROUND OF THE INVENTION

1. Field of the Invention

The present invention relates to a protective sheet used for protecting a photoconductor, an image forming method, and an image forming apparatus.

The present invention also relates to an image forming apparatus and a process cartridge using a protective agent used for protecting a photoconductor and a cleaning blade from mechanical stress such as frictional force in the image forming apparatuses such as copiers, printers, facsimiles, etc.

2. Description of the Related Art

In an image forming apparatus utilizing electrophotographic process, image formation is carried out by subjecting a photoconductor to a charging step, an exposing step, a developing step and transferring step. Subsequently, discharge products which are generated in the charging step and remaining on the photoconductor surface, and toner residues or toner components remaining on the photoconductor surface after the transferring step are removed through a cleaning step.

As a cleaning system commonly used in the cleaning step, a rubber blade which is less expensive and superior in cleanability and has a simple mechanism is used. The cleaning blade, however, is press-contacted to a surface of a photoconductor so as to remove residues on the photoconductor surface, and thus a large mechanical stress is caused by friction between the photoconductor surface and the cleaning blade, the cleaning blade is abraded, in particular, in an organic photoconductor, its surface layer is abraded, undesirably, shortening the operating life of the cleaning blade and the organic photoconductor.

Toners for use in image formation have become smaller in size in response to demands for obtaining higher quality of images. In an image forming apparatus using such a toner having small particle diameter, the toner residues frequently pass through a cleaning blade, and in particular when the dimensional accuracy of a cleaning blade and assembling accuracy of the cleaning blade are insufficient or a part of the cleaning blade vibrates, passing through of toner occurs at very high rate. This problem has been preventing the formation of high-quality images.

For satisfying this demand, the following method or the like is used in practice. For example, a brush roller is pushed against a lubricant (protective agent), and then rotated so as to form a protective agent into powder, and supply the powder to a photoconductor, followed by forming a film of the lubricant using a cleaning blade. The lubricant is present between the photoconductor and the cleaning blade, so that the cleaning blade and a surface of the photoconductor are protected with the lubricant, thereby decreasing in abrasion of the photoconductor and degradation of the cleaning blade, which are caused by friction between the cleaning blade and the photoconductor, and in degradation of the photoconductor caused by discharge energy generated upon charging the photoconductor. Moreover, since the lubricity of the surface of the photoconductor is increased by applying the lubricant to the photoconductor, a phenomenon that the cleaning blade partly vibrates is reduced, and the amount of toner passing through between the photoconductor and the blade decreases. However, since the lubricant is supplied to the rotating photoconductor upon image formation, the photoconductor before image formation is not coated with the lubricant, unless the photoconductor is previously coated with the lubricant in a film form. At the beginning of the image formation therefore the lubricity between the photoconductor and the cleaning blade is poor, causing the deterioration of the blade and the photoconductor.

Moreover, in recent years, as the image forming apparatuses, color image forming apparatuses have become a mainstream. Since high quality images are desired, as a charge system of mainstream, an AC charging system in which direct voltage and alternating voltage are superimposed by using a charging roller as a charger. Moreover, the AC charging system using the charging roller can meet the needs of downsizing. The AC charging system is highly desired, because such system emits less the oxidized gas, such as ozone, NOx etc. However, in the case of a DC charging system, a photoconductor is charged by positive discharge only once while the photoconductor passes through a charger. On the other hand, in the case of the AC charging system, a photoconductor is charged by repeating positive and negative discharge at several hundreds times to several thousands times per second, depending on frequency. Thus, in the AC charging system the hazard to the photoconductor is extremely large compared to that in the DC charging system, and the function of protecting the photoconductor is more important in the AC charging system.

To satisfy the requirements of applying a large amount of a protective agent to a photoconductor and of cleaning toner having a small particle size, there have been attempts to enhance the cleaning effect using a cleaning blade, but which causes the acceleration of the deterioration of the cleaning blade.

Moreover, in the case where a pressure for pressing a brush roller against the protective agent is increased to apply a large amount of the protective agent to the photoconductor, the protective agent having large particles is supplied to the photoconductor, and there arises problems that the particles easily pass through between the photoconductor and the blade, and that it is difficult to uniformly coat the photoconductor with the protective agent.

The toner and lubricant such as a metal soap passed through between the photoconductor and the blade are scattered and attached to a charging roller, and fixed thereto, causing charging failure. Thus, preventing contamination of the charging roller has been also a challenge to be achieved.

Conventionally, there has been a tendency that only a service life of a photoconductor is extended, while a charging roller and a cleaning blade are replaced when they are degraded. However, from the standpoint of environmental concerns, there has been increasing needs to extend service lives of all members such as a charging roller, a cleaning blade, and a photoconductor, etc. Thus, there has been a demand for a technology of preventing the members from degradation and contamination.

In the case where a metal soap is used, there is a problem that the powder of the metal soap supplied to the photoconductor passes through between the photoconductor and the blade in a powder state, and is scattered to the charging roller and fixed thereon, causing charging failure. To solve the problem, instead of the metal soap as the protective agent for the photoconductor, a protective agent containing a metal soap, in which boron nitride (BN) is formulated, has been studied (see, Japanese Patent Application Laid-Open (JP-A) No. 2008-134467). According to JP-A No. 2008-134467, it has been reported that by formulating boron nitride (BN) in the metal soap (zinc stearate), the scattering of the metal soap powder to the charging roller, and blade abrasion can be decreased for a long period of time. It has been found that mixing an inorganic lubricant of boron nitride (BN) in a metal soap is effective.

Furthermore, the lubricant can be used instead of a bar of zinc stearate which has been conventionally used. However, as boron nitride is very expensive, the cost of the lubricant becomes extremely high, compared to that of those conventionally used, although boron nitride is highly effective when supplied to a photoconductor.

### BRIEF SUMMARY OF THE INVENTION

An object of the present invention is to provide a protective sheet which decreases an amount of boron nitride for use, and can prevent degradation in image quality even when a photoconductor is used for a long period of time, and an image forming method.

Another object of the present invention is to provide an image forming apparatus, which can continuously print high quality images for a long period of time at less expensive cost, particularly, to provide the image forming apparatus including a photoconductor, a charging roller, a cleaning blade, and a blade for applying a protective agent, each having extended service life, wherein the members and a process cartridge are less frequently replaced.

To solve the above problems, the inventors of the present invention intensively have studied to achieve a system which extends service lives of all members, for the purpose of extending not only the service life of the photoconductor, but also the service lives of all members located around the photoconductor, including the cleaning blade, the charging roller, an intermediate transfer belt, etc. Firstly, the inventors consider that by decreasing the frictional force between the cleaning blade and the photoconductor, the service lives of both the cleaning blade and the photoconductor can be extended. Thus, they consider a method for decreasing the frictional force between the cleaning blade and the photoconductor.

As the method for decreasing the frictional force, a method of application of a metal soap has been widely known. Although the metal soap contributes to extend the service life of the photoconductor, when the metal soap is continuously applied to the photoconductor to decrease the frictional force, degraded metal soap accelerates the degradation of the cleaning blade. Thus, by using the metal soap alone, the service lives of both the photoconductor and the cleaning blade cannot be extended. Thus, the inventors have studied instead of the metal soap, a lubricant which decreases the frictional force between the cleaning blade and the photoconductor. They have considered a method of providing the lubricants such as silicone resins, acrylic resins, ethylene-acrylic resins, fluorine resins, etc. between the cleaning blade and the photoconductor. However with such lubricant the effect of suppressing the minute vibration of the blade decreases as a number of images formed increases. Due to the occurrence of the minute vibration of the blade, the blade is degraded, failing to achieve the drastic extension of the service life of the blade. When the blade is finely vibrated, the lubricant itself and toner pass through between the photoconductor and the blade, and the materials passed through are scattered and attached to the charging roller, causing charging failure. However, when a large number of images are formed using the photoconductor to which a lubricant prepared by mixing the boron nitride with the metal soap is applied, the service life of the blade is drastically extended, thereby preventing the toner and lubricant from passing through between the photoconductor and the blade, and occurring no charging failure caused by contamination of the charging roller. Thus, it has been found that by the system of supplying the mixture of the metal soap and the boron nitride to the photoconductor, the service lives of all members such as the photoconductor, the blade, and the charging roller can be extended. However, since boron nitride is expensive, the inventors have further studied a method of extending the service lives of the members in a less expensive manner.

When boron nitride is continuously supplied to a photoconductor, the amount of consumption of the boron nitride increases. Contrary to the large consumption amount of the boron nitride, the boron nitride is hardly fixed on the photoconductor, and most of the boron nitride supplied to the photoconductor is used along with toner for development, or discharged along with waste toner. However, a certain amount of the boron nitride adheres to a blade, and the adhered boron nitride is hardly separated from the blade. Since the boron nitride is present between the blade and the photoconductor, the vibration of the blade can be suppressed, thereby preventing the toner from passing through between the photoconductor and the blade.

Therefore, the inventors of the present invention have considered as follows. If a photoconductor has been covered with a protective sheet, onto which surface facing the photoconductor powder of boron nitride adheres, before the photoconductor is used, the powder of the boron nitride may move and adhere from the protective sheet for the photoconductor to the surface of the photoconductor by the time the photoconductor is used, and the boron nitride adhered to the photoconductor may be present between the photoconductor and the blade during the rotation of the photoconductor, and remained therebetween for a long period of time. According to the consideration, a photoconductor is covered with a protective sheet, to which surface facing the photoconductor powder of boron nitride adheres, and maintained for a certain period of time. Then, the protective sheet is removed from the photoconductor, and the photoconductor is mounted in an apparatus, followed by printing images. As a result, the service lives of members such as the photoconductor, a blade, and a charging roller are drastically extended. Moreover, the boron nitride has hardly fixed to the photoconductor which has been used for printing a large number of images, similar to the photoconductor to which the boron nitride is continuously supplied. Therefore, it has been found that it is not necessary to continuously supply boron nitride to a photoconductor, by applying the powder of the boron nitride to a surface of a protective sheet, which surface faces the photoconductor. In the manner as mentioned, the present invention has been achieved.

Means for solving the above problems and achieving the objects of the present invention is as follows.

<1> A protective sheet including a lubricant which contains boron nitride and adheres to the protective sheet, wherein the protective sheet is used to protect a photoconductor.
<2> The protective sheet according to <1>, wherein the lubricant further contains a metal soap.
<3> The protective sheet according to <2>, wherein a mass ratio of the boron nitride is 10% by mass or more, relative to a total mass of the boron nitride and the metal soap contained in the lubricant.
<4> An image forming method, including: removing a protective sheet from a photoconductor; charging the photoconductor, from which the protective sheet has been removed; exposing the charged photoconductor to laser beam so as to form a latent electrostatic image; developing the latent electrostatic image formed on the photoconductor using a developer containing a toner, so as to form a toner image; transferring the toner image from the photoconductor to a transfer medium; and cleaning the photoconductor, from which the toner image has been transferred, using a cleaning blade, wherein the protective sheet comprises a lubricant which contains boron nitride and adheres to the protective sheet, and wherein the protective sheet is used to protect the photoconductor.
<5> The image forming method according to <4>, wherein the cleaning is performed by bringing the cleaning blade into contact with the photoconductor by a counter system.
<6> The image forming method according to <4>, wherein the cleaning blade has a tip which is brought into contact with the photoconductor, and the tip is in the shape of an obtuse angle.
<7> The image forming method according to <4>, further containing supplying the cleaned photoconductor with a protective agent containing a metal soap.
<8> The image forming method according to <7>, wherein the protective agent further contains boron nitride, and a mass ratio of the boron nitride is 30% by mass or less, relative to a total mass of the boron nitride and the metal soap contained in the protective agent.
<9> An image forming apparatus including: a photoconductor; a charging unit configured to charge a surface of the photoconductor; a latent electrostatic image forming unit configured to form a latent electrostatic image on the charged surface of the photoconductor; a developing unit configured to develop the latent electrostatic image on the surface of the photoconductor using a developer containing a toner so as to form a toner image; a transferring unit configured to transfer the toner image from the surface of the photoconductor to a transfer medium; and a cleaning unit configured to remove the toner remaining on the surface of the photoconductor, from which the toner image has been transferred, wherein the photoconductor has a lubricant containing boron nitride adhered to the surface thereof, and the lubricant is applied to the surface of the photoconductor by covering the photoconductor with a protective sheet so that a surface of the protective sheet having the lubricant adhered thereto faces the photoconductor, and removing the protective sheet from the photoconductor.
<10> The image forming apparatus according to <9>, wherein the lubricant is a mixture of a metal soap and the boron nitride.
<11> The image forming apparatus according to <10>, wherein a mass ratio of the boron nitride is 10% by mass or more, relative to a total mass of the metal soap and the boron nitride contained in the lubricant.
<12> The image forming apparatus according to <9>, further containing a protective agent application unit configured to apply a metal soap as a protective agent to the photoconductor.
<13> The image forming apparatus according to <12>, wherein the protective agent further contains boron nitride, and a mass ratio of the boron nitride is 30% by mass or less, relative to a total mass of the metal soap and the boron nitride contained in the protective agent.
<14> The image forming apparatus according to <12>, further including a blade as a protective agent layer thinning unit, in addition to the cleaning unit.
<15> The image forming apparatus according to <14>, wherein the boron nitride or a mixture of the metal soap and the boron nitride adheres to the blade as the protective agent layer thinning unit before the blade is started to use.
<16> The image forming apparatus according to <14>, wherein the blade as the protective agent layer thinning unit is brought into contact with the photoconductor at an angle for use in a counter system.
<17> The image forming apparatus according to <14>, wherein the blade as the protective agent layer thinning unit has a tip which is brought into contact with the photoconductor, and the tip is in the shape of an obtuse angle.

According to the present invention, there can be provided a protective sheet which decreases an amount of boron nitride for use, and can prevent degradation in image quality even when a photoconductor is used for a long period of time, and an image forming method.

According to the present invention, there can be provided an image forming apparatus, which can continuously printing high quality images for a long period of time at less expensive cost, particularly, the image forming apparatus including a photoconductor, a charging roller, a cleaning blade, and a blade for applying a protective agent, each having extended service life, wherein the members and a process cartridge are less frequently replaced.

### BRIEF DESCRIPTION OF THE DRAWINGS

FIG. 1 is a view shows an example of a process cartridge used in the present invention.

FIG. 2A is a view showing a state of a cleaning blade in contact with a photoconductor.

FIG. 2B is a view showing another state of a cleaning blade in contact with a photoconductor.

FIG. 3 shows an example of a conversion of the process cartridge shown in FIG. 1.

FIG. 4 shows another example of a conversion of the process cartridge shown in FIG. 1.

FIG. 5 is a view showing an example of an image forming apparatus used in the present invention.

FIG. 6A is a schematic diagram showing a case where a blade as a protective agent layer thinning unit has a tip in contact with a photoconductor and in the shape of an angle of 90°.

FIG. 6B is a schematic diagram showing a case where a tip of the blade as the protective agent layer thinning unit is drawn along the rotation.

FIG. 6C is a schematic diagram showing a case where the blade as the protective agent layer thinning unit has a tip in contact with a photoconductor and in the shape of an angle of more than 90° (obtuse angle).

FIG. 6D is a schematic diagram showing a case where the blade as the protective agent layer thinning unit has a tip in contact with a photoconductor and in the shape of an angle of less than 90° (sharp angle).

FIG. 7A is a schematic diagram showing a case where the blade as the protective agent layer thinning unit is in contact with a photoconductor by counter system.

FIG. 7B is a schematic diagram showing a case where the blade as the protective agent layer thinning unit is in contact with a photoconductor by a trailing (trading) system.

### DETAILED DESCRIPTION OF THE INVENTION

### Protective Sheet

A protective sheet of the present invention contains a lubricant which contains boron nitride and adheres to the protective sheet, and wherein the protective sheet is used to protect the photoconductor.

When a photoconductor is stored in a state that the photoconductor is covered with the protective sheet of the present invention, to which surface facing the photoconductor the lubricant adheres, the lubricant containing boron nitride moves from the protective sheet to the photoconductor. Such photoconductor is used in an image forming apparatus having a blade such as a cleaning blade, and the boron nitride adheres to the blade. The boron nitride improves lubricity between the blade and the photoconductor, thereby suppressing minute vibration of the blade. Thus, it is considered that the lubricant containing boron nitride is used to prevent a metal soap which will be described below and toner from passing through between the photoconductor and the blade, and adhering to a charging roller, thereby suppressing of formation of streaky image. Moreover, by suppressing the blade vibration, abrasion of the blade is decreased. Since, during the use of the blade, the boron nitride hardly separated from the lubricant, the amount of the boron nitride to be used can be decreased, and image quality degradation can be suppressed even though the photoconductor is used for a long period of time.

Moreover, the protective sheet of the present invention also provides excellent lubricity to a photoconductor.

Duration of storing the photoconductor covered with the protective sheet of the present invention is not particularly limited, as long as the lubricant containing the boron nitride moves from the protective sheet to the photoconductor, and the static properties of the photoconductor can be maintained.

The primary particle size or secondary particle size of the boron nitride is usually about 10 μm, preferably about 2 μm to about 8 μm.

In the protective sheet of the present invention, the average adhesion amount of the boron nitride is usually 0.002 mg/cm² to 2 mg/cm², preferably 0.003 mg/cm² to 1 mg/cm². When the average adhesion amount is less than 0.002 mg/cm², the lubricity between the cleaning blade and the photoconductor becomes insufficient, and effect of preventing minute vibration of the cleaning blade may not be exhibited. On the other hand, when the average adhesion amount is more than 2 mg/cm², boron nitride falls down as the protective sheet is removed from a photoconductor, and may contaminate a surrounding area of the photoconductor.

The boron nitride may be subjected to surface treatment for the purpose of improving hydrophobicity.

Moreover, considering that frictional force between the photoconductor and the blade easily increases since a toner dose not present on a surface of the photoconductor immediately after beginning to use the photoconductor, it is preferred that the lubricant further contain a metal soap. By containing the metal soap in the lubricant, the lubricity between the photoconductor and the blade can be further improved. As the blade used, the metal soap is separated. However, since a toner is present on the surface of the photoconductor, the lubricity between the photoconductor and the blade can be maintained.

The metal soap is not particularly limited and may be appropriately selected depending on the intended purpose. Examples of the metal soap include zinc stearate, magnesium stearate, ferric stearate, calcium stearate, zinc laurate, zinc palmitate, and zinc oleate. These may be used alone or in combination.

The primary particle size or secondary particle size of the metal soap is preferably about 0.1 μm to several micrometers.

The mass ratio of the boron nitride is usually 10% or more, preferably 30% to 90%, more preferably 50% to 80%, relative to the total mass of the boron nitride and the metal soap. When the mass ratio is less than 10%, the lubricity between the photoconductor and the blade may be insufficient.

The lubricant is not particularly limited as long as it contains boron nitride. The lubricant may further contain fluorine resins such as polytetrafluoroethylene (PTFE), polyperfluoroalkylether (PFA), perfluoroethylene-perfluoropropylene copolymer (FEN, polyvinylidenefluoride (PVdF), and ethylene-tetrafluoroethylene copolymer (ETFE); silicone resins such as polymethyl silicone, polymethylphenyl silicone; acrylic resin; ethylene acrylate resin; inorganic compounds such as mica, molybdenum disulfide, tungsten disulfide, kaolin, montmorillonite, calcium fluoride and graphite; lubricating materials such as toner, or the like. The inorganic compound may be subjected to surface treatment for the purpose of improving hydrophobicity.

Generally, the photoconductor is easily damaged, and fatigue phenomenon easily occurs in the static properties thereof by exposing the photoconductor to external light. Thus, after the photoconductor is produced, it is covered with the protective sheet. The photoconductor covered with the protective sheet is shipped out in a state that the photoconductor is mounted in an image forming apparatus, or in a state that the photoconductor is mounted in a process cartridge. Alternatively, the photoconductor alone is shipped out for replacement of the photoconductor. In any case, when the photoconductor is started to use, a user or a serviceman preferably take out the protective sheet from the photoconductor. When the photoconductor covered with the protective sheet is shipped out, the photoconductor is not easily subject to light-induced fatigue or damage, until the protective sheet is taken out from the photoconductor. Meanwhile, as the removal of the protective sheet from the photoconductor is a simple operation, even a user removing the protective sheet for the first time can easily operate it.

Generally, the place where a photoconductor is produced, the place where the photoconductor is mounted in the image forming apparatus and the place where a user uses the photoconductor are not the same in many cases. Thus, the photoconductor covered with the protective sheet is preferably transported.

Note that “serviceman” means a person who provide maintenance service, such as replacement of replacement parts, periodic maintenance, handling failure, and the like.

A material of the protective sheet is not particularly limited as long as it prevents the photoconductor from being damaged and exposed to external light when the photoconductor is transported, and may be appropriately selected depending on the intended purpose. Black lightproof paper containing carbon black or the like is preferred, because the part of the protective sheet where an adhesive tape is affixed can be easily removed by tearing part of the protective sheet.

The breaking properties of the black lightproof paper can be easily adjusted by an amount of the carbon black, etc. to be added in the black lightproof paper. Moreover, the deterioration of the photoconductor caused by static electricity can be effectively reduced by black lightproof paper because of the function of the carbon black, etc.

As the material of the protective sheet, a material having rigidity smaller than that of the photoconductor, for example, a synthesis resin sheet such as a polyethylene sheet may be used, instead of paper.

The surface area of the protective sheet is not particularly limited as long as it covers an area where a photosensitive layer of the photoconductor is formed, and can be packed.

The thickness of the protective sheet is normally 0.05 mm to 0.5 mm, preferably 0.08 mm to 0.3 mm, more preferably 0.1 mm to 0.2 mm. When the thickness of the protective sheet is less than 0.05 mm, it may not prevent a photoconductor from being damaged and exposed to external light, when a photoconductor is transported. When the thickness of the protective sheet is more than 0.5 mm, it may be difficult to remove the part of the protective sheet where an adhesive tape is affixed by tearing part of the protective sheet.

When the lubricant is applied to the protective sheet, the lubricant may be applied to a surface of the protective sheet using a brush, sponge (sponge puff for cosmetics), etc., to which the lubricant is applied. Alternatively, the lubricant may be applied to a surface of the protective sheet by tapping the surface of the protective sheet with a finely-woven fabric by which the lubricant is wrapped.

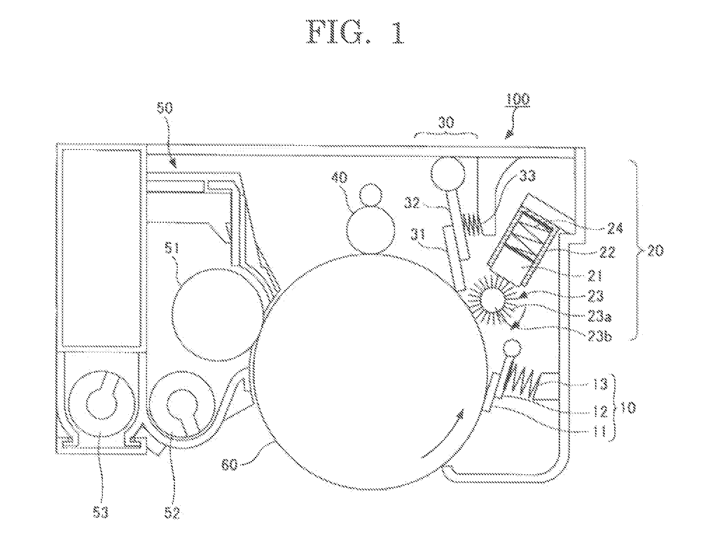

FIG. 1 shows an example of a process cartridge used in the present invention. A process cartridge 100 includes a photoconductor 60, a charging roller 40 configured to charge the photoconductor 60, a developing unit 50 configured to develop a latent electrostatic image formed by exposing the charged photoconductor 60 to laser beam using a developer containing a toner so as to form a toner image, a cleaning unit 10 configured to clean the photoconductor 60 from which the toner image has been transferred to a transfer medium (not shown), a protective agent application unit 20 configured to apply a protective agent containing a metal soap to the cleaned photoconductor 60, a protective agent layer thinning unit 30 configured to form the protective agent applied to the photoconductor 60 into a thin layer.

The cleaning unit 10 includes a cleaning blade 11, a support 12 for supporting the cleaning blade 11, a pressing force mechanism 13, such as a spring, for pressing the cleaning blade 11 against the drum-shaped photoconductor 60 via the support 12.

The lubricant containing boron nitride adheres onto a tip of the cleaning blade 11, since the tip of the cleaning blade 11 is brought into contact with the photoconductor 60.

The cleaning blade 11 is brought into contact with the photoconductor 60 by counter system, so as to prevent an excessive amount of the lubricant from adhering to the surface of the photoconductor 60.

It is noted that the counter system means that the cleaning blade 11 is brought into contact with the photoconductor 60 at an angle of less than 90° with respect to the moving direction of the photoconductor 60.

The material used for a cleaning blade 11 is not particularly limited, and may be appropriately selected depending on the intended purpose. Examples thereof include elastic materials such as urethane rubbers, hydrin rubbers, silicone rubbers and fluorine rubbers. These elastic materials may be used in combination. Further, in order to adjust the hardness of the cleaning blade 11, fillers such as organic fillers or inorganic fillers may be dispersed in the elastic material. Additionally, a portion of the cleaning blade 11, which is brought into contact with the photoconductor 60, may be coated or impregnated with a low friction coefficient material.

The thickness of the cleaning blade 11 is normally about 0.5 mm to about 5 mm, and preferably about 1 mm to about 3 mm. The length of the cleaning blade 11 is normally about 1 mm to about 15 mm, and preferably about 2 mm to about 10 mm.

A method for fixing the cleaning blade 11 to the support 12 is not particularly limited, and may be appropriately selected depending on the intended purpose. Examples thereof include adhesion, and fusion bonding.

The linear pressure for pressing the cleaning blade 11 against the photoconductor 60 is normally 5 gf/cm to 80 gf/cm, preferably 10 gf/cm to 60 gf/cm.

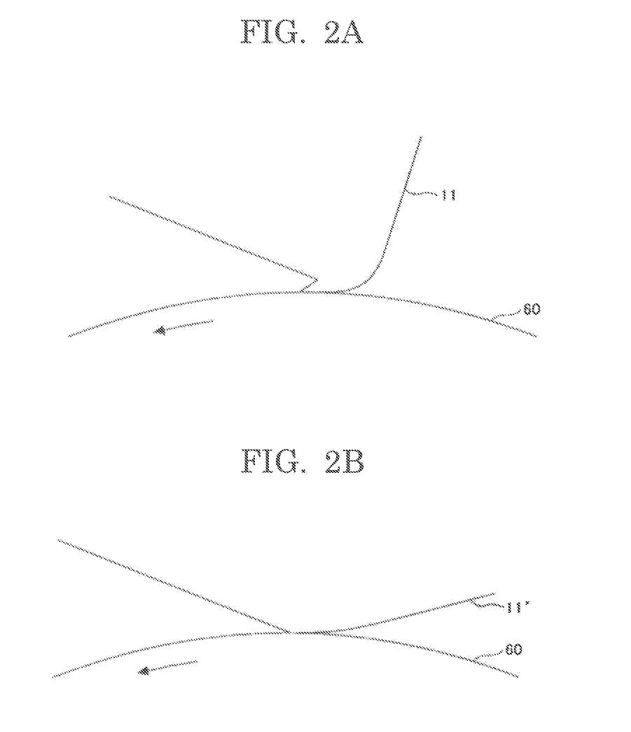

The cleaning blade 11 has a tip, which is brought into contact with the photoconductor 60, and in the shape of a right angle, but may have the tip in the shape of an obtuse angle. In the case where the cleaning blade 11 has a tip, which is brought into contact with the photoconductor 60, and in the shape of a right angle, the tip of the cleaning blade 11 is easily drawn along the rotation of the photoconductor 60 as shown in FIG. 2A. On the other hand, in the case where the cleaning blade 11′ has a tip, which is brought into contact with the photoconductor 60, and in the shape of an obtuse angle, the tip of the cleaning blade 11′ is not easily drawn along the rotation of the photoconductor 60 as shown in FIG. 2B. Thus, it is considered that cleaning blade is an obtuse angled blade stably cleans the photoconductor 60.

The protective agent application unit 20 includes a protective agent bar 21 obtained by forming a protective agent containing a metal soap into a circular, quadrangular, or hexagonal shape, etc., a support guide 22 for supporting the protective agent bar 21 so as not to swing it, a brush roller 23 for applying the protective agent supplied from the protective agent bar 21 to fibers 23a onto a surface of the photoconductor 60, and a pressing force mechanism 24 such as a spring for pressing the protective agent bar 21 against the brush roller 23 so as to supply the protective agent to the brush roller 23, wherein the brush roller 23 is formed by planting fibers 23a, which is brought into contact with the protective agent bar 21, on a metal core 23b, or formed by spirally winding a tape made of a pile-woven fabric formed of fibers 23a around a metal core 23b, in which fibers 23a are pile-woven in a base fabric.

By pressing the protective agent bar 21 against the brush roller 23, the protective agent is supplied from the protective agent bar 21 to the brush roller 23. By changing the pressing force, the supply amount of the protective agent can be changed. The brush roller 23 is rotated at a faster linear velocity than that of the photoconductor 60, so as to slidingly rub the surface of the photoconductor 60 with a tip of the brush roller 23, to thereby apply the protective agent held on a surface of the brush roller 23 to the surface of the photoconductor 60. Moreover, by forming the protective agent into a thin layer while the protective agent is applied to the surface of the photoconductor 60, it makes easier to hold the protective agent on the surface of the photoconductor 60. As a result, formation of abnormal images caused by adhesion of the protective agent to the charging roller 40 can be suppressed.

The metal soap contained in the protective agent is not particularly limited and may be appropriately selected depending on the intended purpose. Examples of the metal soap include zinc stearate, magnesium stearate, ferric stearate, calcium stearate, zinc laurate, zinc palmitate, and zinc oleate. These may be used alone or in combination. Among these, the metal soap containing zinc palmitate and zinc stearate is preferable.

In the case where zinc stearate is used as the metal soap, when the linear velocity of the photoconductor increases, it may be difficult to form the metal soap into a thin layer on the surface of the photoconductor. In the case where the mixture of zinc stearate and zinc palmitate is used as the metal soap, even when the linear velocity of the photoconductor is high, the metal soap is sufficiently formed into a thin layer on the surface of the photoconductor. This is because zinc palmitate is highly compatible with zinc stearate, and has a melting point lower than that of the zinc stearate.

The mass ratio of the zinc stearate and the zinc palmitate is normally 75:25 to 40:60, preferably 66:34 to 40:60.

The protective agent further contains boron nitride, and the mass ratio of the boron nitride relative to the total mass of the boron nitride and the metal soap contained in the protective agent is preferably 30% or less, more preferably 10% or less. Thus, the lubricity between the cleaning blade 11 or a blade 31, which will be described below, and the photoconductor 60 can be maintained for a long period of time. When the mass ratio is more than 30%, an excessive amount of the boron nitride adheres to a surface of the photoconductor, possibly causing problems.

The protective agent preferably further contains alumina. By containing alumina therein, the metal soap and the boron nitride excessively applied onto a surface of the photoconductor 60 can be grinded.

The amount of the alumina in the protective agent is normally 2% by mass to 15% by mass, preferably 3% by mass to 10% by mass, still more preferably 4% by mass to 8% by mass, relative to the metal soap. When the amount of the alumina is less than 2% by mass, the alumina may not be able to sufficiently grind the metal soap and the boron nitride. When the amount of the alumina is more than 15% by mass, the alumina may easily damage a photoconductor.

The average particle diameter of the alumina is normally 0.05 μm to 0.5 μm, preferably 0.1 μm to 0.4 μm, still more preferably 0.2 μm to 0.3 μm. When the average particle diameter of the alumina is less than 0.05 μm, the alumina may not be able to sufficiently grind the metal soap and the boron nitride. When the average particle diameter of the alumina is more than 0.5 μm, the alumina may easily damage a photoconductor.

A method for producing the protective agent bar 21 is not particularly limited and may be appropriately selected depending on the intended purpose. Examples thereof include a melt molding method, in which a protective agent is melted, and loaded into a mold, followed by cooling; and a compression molding method, in which powder of a protective agent is compressed.

The brush roller used as the brush roller 23 is not particularly limited and may be appropriately selected depending on the intended purpose. It is exemplified by a brush roller formed by spirally winding a tape made of a pile fabric formed of fibers 23a around a metal core 23b.

A material of the fibers 23a of the brush roller 23 is not particularly limited as long as they have flexibility, and may be appropriately selected depending on the intended purpose. Examples thereof include polyolefin resins (e.g. polyethylene, polypropylene, etc.); polyvinyl resins or polyvinylidene resins (e.g., polystyrene, acrylic resin, polyacrylonitrile, polyvinyl acetate, polyvinyl alcohol, polyvinyl butyral, polyvinyl chloride, polyvinyl carbazole, polyvinyl ether, polyvinyl ketone, etc.); vinyl chloride-vinyl acetate copolymers; styrene-acrylic acid copolymers; styrene-butadiene resins; fluorine resins (e.g., polytetrafluoroethylene, polyvinyl fluoride, polyvinylidene fluoride, polychlorotrifluoroethylene, etc.); polyesters; nylons; acryls; rayons; polyurethanes; polycarbonates; phenol resins; and amino resins (e.g., urea-formaldehyde resins, melamine resins, benzoguanamine resins, urea resins, polyamide resins, etc.). These may be used alone or in combination.

The fibers 23a may be compounded with a diene rubber, styrene-butadiene rubber (SBR), ethylene propylene rubber, isoprene rubber, nitrile rubber, urethane rubber, silicone rubber, hydrin rubber, norbornene rubbers or the like, in order to adjust the flexibility,

The fibers 23a each normally have a diameter of 10 μm to 500 μm, and preferably 20 μm to 300 μm. When the diameter of each fiber 23a is less than 10 μm, the coating speed of the protective agent may not be sufficient. When the diameter of each fiber 23a is more than 500 μm, the protective agent may be applied nonuniformly.

The fibers 23a each normally have a length of 1 mm to 15 mm, and preferably 3 mm to 10 mm. When the length of each fiber 23a is shorter than 1 mm, the core metal 23b may be easily brought into contact with the photoconductor 60. When the length of each fiber 23a is longer than 15 mm, it may be difficult to sufficiently supply the surface of the photoconductor 60 with the protective agent.

The fibers 23a generally have a density of 10,000 fibers per square inch to 300,000 fibers per square inch (or 1.5×10⁷ fibers per square meter to 4.5×10⁸ fibers per square meter). When the density is less than 10,000 fibers per square inch, the protective agent may not be uniformly applied to the photoconductor. When the density is more than 300,000 fibers per square inch in the brush roller 23, a diameter of each of the fibers 23a is necessary to be small.

From the viewpoint of stability and uniformity in application of the protective agent, the fibers 23a are preferably formed of from several fine filaments to several-hundreds of fine filaments. For example, as in 333 decitex=6.7 decitex×50 filaments (300 denier=6 denier×50 filaments), it is preferred that 50 fine filaments of 6.7 decitex (6 denier) be bundled into the fibers 23a.

Since the fibers 23a have high efficiency of application of the protective agent, each of the fibers 23a may be a monofilament having a diameter of 28 μm to 43 μm, preferably 30 μm to 40 μm. When the diameter of the monofilament is less than 28 μm, the efficiency of the application of the protective agent may decrease. When the diameter of the monofilament is more than 43 μm, the photoconductor 60 may be easily damaged. The monofilament is preferably vertically planted on the metal core 23b. It is preferred to produce the brush roller 23 by taking advantage of static electricity, so-called electrostatic flocking. The electrostatic flocking is a method of planting filaments, in which the metal core 23b is coated with an adhesive, and charged, and then monofilaments are scattered by electrostatic force, followed by curing the adhesive. The monofilaments have a density of 50,000 per square inch to 600,000 per square inch.

For the purpose of stabilizing the surface shape of the brush roller and achieving environmental stability, a coating layer may be formed on a surface of the fibers 23a.

A material used for the coating layer is not particularly limited, as long as it has flexibility, and may be appropriately selected depending on the intended purpose. Examples thereof include polyolefin resins such as polyethylene, polypropylene, polyethylene chloride, and chlorosulfonated polyethylene; polyvinyl and polyvinylidene resins such as polystyrene, acryls (e.g., polymethyl methacrylate), polyacrylonitrile, polyvinyl acetate, polyvinyl alcohol, polyvinyl butyral, polyvinyl chloride, polyvinyl carbazole, polyvinyl ether, and polyvinylketone; vinyl chloride-vinyl acetate copolymers; silicone resins or silicone resins modified with an alkyd resin, polyester resin, epoxy resin, polyurethane resin, or the like; fluorine resins such as perfluoroalkyl ether, polyfluorovinyl, polyfluorovinylidene, and polychlorotrifluoroethylene; polyamides; polyesters; polyurethanes, polycarbonates; amino resins such as urea-formaldehyde resin; epoxy resins. These may be used alone or in combination.

Instead of application of the protective agent onto a surface of the photoconductor 60 using the protective agent application unit 20, powder of the protective agent may be supplied to the surface of the photoconductor 60. In this case, a container for containing the powder of the protective agent and a protective agent transport unit for transporting the powder of the protective agent can be used. The protective agent transport unit is not particularly limited, and may be appropriately selected depending on the intended purpose. Examples thereof include a pump and an auger.

The protective agent layer thinning unit 30 includes a blade 31, support 32 for supporting the blade 31, and a pressing force mechanism 33 such as a spring, for pressing the blade 31 against the drum-shaped photoconductor 60 via the support 32.

The lubricant containing boron nitride adheres onto a tip of the blade 31, since the tip of the cleaning blade 31 is brought into contact with the photoconductor 60.

Since the blade 31 is brought into contact with the photoconductor 60 in a counter system, the blade 31 prevents the excessive amount of the lubricant from adhering to the surface of the photoconductor 60.

A material used for the blade 31 is not particularly limited, and may be appropriately selected depending on the intended purpose. Examples thereof include elastic materials such as urethane rubbers, hydrin rubbers, silicone rubbers and fluorine rubbers. These may be used alone or in combination. Further, in order to adjust the hardness of the blade 31, fillers such as organic fillers or inorganic fillers may be dispersed in the blade 31. Additionally, a portion of the blade 31, which is brought into contact with the photoconductor 60, may be coated or impregnated with a low friction coefficient material.

The thickness of the blade 31 is normally about 0.05 mm to about 5 mm, preferably 1 mm to 3 mm. The length of the blade 31 is normally about 1 mm to about 15 mm, preferably 2 mm to 10 mm.

A method for fixing the blade 31 to the support 32 is not particularly limited, and may be appropriately selected depending on the intended purpose. Examples thereof include adhesion, and fusion bonding.

The linear pressure for pressing the blade 31 against the photoconductor 60 is normally 5 gf/cm to 80 gf/cm, preferably 10 gf/cm to 60 gf/cm.

The blade 31 has a tip, which is brought into contact with the photoconductor 60, and is in the shape of a right angle, but may have the tip in the shape of an obtuse angle, similar to the cleaning blade 11. In the case where the blade has a tip, which is brought into contact with the photoconductor 60, and in the shape of an obtuse angle, since the tip of the blade is not easily drawn along the rotation of the photoconductor 60, it is considered that the blade 31 stably forms the protective agent into a thin film.

Instead of the protective agent layer thinning unit 30, an elastic metal blade, such as a leaf spring, on which surface a protective layer is formed, may be used. The thickness of the elastic metal blade is normally about 0.05 mm to about 3 mm, preferably about 0.1 mm to about 1 mm. In order to prevent the elastic metal blade from being twisted, the blade may be bent in a direction substantially parallel to a support shaft after the installation of the blade.

A material for forming the protective layer is not particularly limited and may be appropriately selected depending on the intended purpose. Examples thereof include fluorine resins such as PFA, PTFE, FEP or PVdF; fluorine rubbers; silicone elastomers such as a methylphenyl silicone elastomer. These may be used alone or in combination. Also, in order to adjust the hardness of the protective layer, fillers, such as organic fillers, organic fillers etc., may be dispersed in the protective layer.

A method for forming the protective layer is not particularly limited and may be appropriately selected depending on the intended purpose. For example, coating, dipping or the like is exemplified. The protective layer may be formed on a surface of an elastic blade via a coupler, primer component or the like if necessary by thermosetting. Moreover, the protective layer may be subjected to surface polishing, if necessary.

The charging roller 40 is placed in contact with or close to the photoconductor 60 at a distance of 20 μm to 100 μm, and a superimposed voltage obtained by superimposing an alternating voltage to a direct voltage is applied to the photoconductor 60. Since the superimposed voltage is discharged several hundred times per second between the photoconductor 60 and the charging roller 40, the photoconductor 60 is easily subject to degradation caused by discharge. Moreover, even though the protective agent is applied to the photoconductor 60, the protective agent is easily degraded by discharge. Thus, it is preferred that a certain amount of the protective agent be always applied to the photoconductor 60.

The charging roller 40 is structured in such a manner that a resin layer and a protective layer are sequentially formed on a conductive substrate, and a surface of the charging roller 40 has a dynamic ultra-microhardness of 0.04 to 0.5.

The conductive substrate is not particularly limited as long as it functions as an electrode and a support member of the charging roller 40, and may be appropriately selected depending on the intended purpose. Examples thereof include metals and alloys such as aluminum, copper, and stainless steel; irons plated with chromium, nickel or the like; and resins to which a conductive agent is added.

The elastic layer contains a rubber material and a conductive agent, and has a volume resistivity of 1×10⁶Ω·cm to 1×10⁹Ω·cm.

The rubber material is not particularly limited and may be appropriately selected depending on the intended purpose. Examples thereof include thermoplastic elastomers such as polyester, olefin, styrene thermoplastic resins such as styrene-butadiene copolymers, styrene-acrylonitrile copolymers, styrene-butadiene-acrylonitrile copolymers, isoprene rubbers, chloroprene rubbers, epichlorohydrin rubbers, butyl rubbers, urethane rubbers, silicone rubbers, fluorine rubbers, styrene-butadiene rubbers, butadiene rubbers, nitrile rubbers, ethylene-propylene rubbers, epichlorohydrin-ethyleneoxide copolymer rubbers, epichlorohydrin-ethyleneoxide-allyl glycidyl ether copolymer rubbers, ethylene-propylene-diene-terpolymer (EPDM) rubbers, acrylonitrile-butadiene copolymer rubbers, and natural rubbers. These may be used alone or in combination. Among these, silicone rubbers, ethylene-propylene rubbers, epichlorohydrin-ethyleneoxide copolymer rubbers, epichlorohydrin-ethyleneoxide-allyl glycidyl ether copolymer rubbers, and acrylonitrile-butadiene copolymer rubbers are preferably used. These rubbers may be foaming.

An electron conductive agent or an ion conductive agent may be used as the conductive agent. These may be used in combination.

The electron conductive agent is not particularly limited, and may be appropriately selected depending on the intended purpose. Examples thereof include carbon black such as ketjen black and acetylene black; pyrolytic carbon, graphite; various types of conductive metals and alloys, such as aluminum, copper, nickel, and stainless steel; various types of conductive metal oxides such as tin oxide, indium oxide, titanium oxide, a solid solution of tin oxide-antimony oxide, and a solid solution of tin oxide-indium oxide; and insulation substances whose surfaces have been subjected to conductive treatment.

The amount of the electron conductive agent in the elastic layer is normally 1% by mass to 30% by mass, preferably 15% by mass to 25% by mass, relative to the resin.

The ion conductive agent is not particularly limited, and may be appropriately selected depending on the intended purpose. Examples thereof include perchlorates and chlorates such as tetraethylammonium and lauryl trimethyl ammonium; and perchlorates and chlorates of alkali earth metals and alkali metals such as lithium and magnesium.

The amount of the ion conductive agent in the elastic layer is normally 0.1% by mass to 5.0% by mass, preferably 0.5% by mass to 3.0% by mass, relative to the resin.

The protective layer contains a resin, and may further contain the conductive agent as described above, and fine particles, as necessary.

The resin is not particularly limited and may be appropriately selected depending on the intended purpose. Examples thereof include polyamide, polyurethane, polyvinyl chloride, tetrafluoroethylene copolymers, polyesters, polyimides, silicone resins, acrylic resins, polyvinyl butyral, ethylene-tetrafluoroethylene copolymers, melamine resins, fluorine resins, epoxy resins, polycarbonates, polyvinyl alcohol, cellulose, polyvinylidene chloride, polyvinyl chloride, polyethylene, and polyethylene-vinyl acetate copolymers. These may be used alone or in combination. Among these, polyamide, polyvinylidene fluoride, etrafluoroethylene copolymers, polyesters, and polyimides are preferable in terms of releasing properties of toner.

The number average molecular mass of the resin is normally 1,000 to 100,000, preferably 10,000 to 50,000.

The fine particles are not particularly limited and may be appropriately selected depending on the intended purpose. Examples thereof include metal oxides and combined metal oxides such as silicon oxide, aluminum oxide, barium titanate; and resins such as polytetrafluoroethylene, and vinylidene fluoride. These may be used alone or in combination.

The developing unit 50 includes a developing roller 51 conveying a developer containing a toner while carrying it, and stirring and conveying screws 52 and 53 conveying the developer while stirring it. The developing roller 51 is partially exposed from an opening of a casing of the developing unit 50. The developer used may be a two component developer consisting of toner and carrier or a one component developer containing no carrier.

Next, a method of developing a latent electrostatic image using the two component developer will be described. The toner loaded into the developing unit 50 from a toner bottle (not shown), is conveyed by the stirring and conveying screws 52 and 53 while being stirred together with carrier and the carrier is borne on the developing roller 51. The developing roller 51 consisting of a magnet roller which generates a magnetic field and a developing sleeve coaxially rotating around the magnet roller. The carrier is conveyed to a developing section facing the photoconductor 60, while the carrier in the developer stands on the developing roller 51 by magnetic force generated with the magnet roller. Here, a surface of the developing roller 51 is moved to the same direction at a linear velocity faster than that of the surface of the photoconductor 60 in the developing section. Then, the surface of the photoconductor 60 is supplied with the toner adhered to the carrier, while the carrier standing on the developing roller 51 slidingly rubs the surface of the photoconductor 60. At this time, a developing bias is applied to the developing roller 51 from an electric source (not shown), whereby a developing electrical field is formed in the developing section. Thereby, the toner on the developing roller 51 adheres to the latent electrostatic image on the photoconductor 60. Upon adhesion, the latent electrostatic image on the photoconductor 60 is developed into a toner image.

The photoconductor 60 includes a photosensitive layer formed on the conductive substrate. As the photosensitive layer, there are provided a single-layered photosensitive layer in which a charge generating material and a charge transporting material are mixed, a photosensitive layer of normal order layer constitution type in which a charge transporting layer is provided on a charge generating layer, and a photosensitive layer of inverse order layer constitution type in which a charge generating layer is provided on a charge transporting layer. The protective layer may be provided on the photosensitive layer, and an undercoat layer may be provided between the photosensitive layer and the conductive substrate.

The conductive substrate is not particularly limited as long as it exhibits a volume resistivity of 1.0×10¹⁰ Ω·cm or lower. For example, the s substrate may be prepared by applying a metal such as aluminum, nickel, chromium, nichrome, copper, gold, silver, or platinum or the like, or a metal oxide such as tin oxide or indium oxide or the like, for example, by vapor deposition or sputtering, onto film-form or cylindrical plastic or paper, or using a sheet of aluminum, aluminum alloy, nickel, or stainless steel or the like, and making it into a crude tube by extrusion or drawing or the like, and then surface-treating the tube by cutting, super-finishing, or grinding or the like.

The drum-shaped substrate normally has a diameter of 20 mm to 150 mm, preferably 24 mm to 100 mm, more preferably 28 mm to 70 mm. When the diameter of the drum-shaped substrate is smaller than 20 mm, it becomes difficult to arrange each individual member for charging, exposing, developing, transferring, and cleaning around the photoconductor 60. When it is greater than 150 mm, the image forming apparatus itself may be large in size. In particular, in the case of an image forming apparatus 1000, there is a need to provide a plurality of photoconductors 60, and thus the diameter of the conductive substrate is normally 70 mm or smaller, preferably 60 mm or smaller. Also, the endless nickel belt and endless stainless belt disclosed in Japanese Patent Application Publication (JP-B) No. 52-036016 may also be used as the conductive substrate.

Examples of the undercoat layer include a film primarily containing a resin or a white pigment and a resin, and a metal-oxide film in which a surface of a conductive substrate is chemically or electrochemically oxidized. The film primarily containing a white pigment and a resin is preferable. The undercoat layer of the photoconductor may be a single layer or may be formed of a plurality of layers.

The resin is not particularly limited, and may be appropriately selected depending on the intended purpose. Examples of the resin include thermoplastic resins such as polyamides, polyvinyl alcohol, casein, and methyl cellulose; and thermosetting resins such as acrylic resins, phenol resins, melamine resins, alkyd resins, unsaturated polyester resins, and epoxy resins. These may be used alone or in combination.

Examples of the white pigment include metal oxides such as titanium oxide, aluminum oxide, zirconium oxide, and zinc oxide. Among these, particularly preferred is a titanium oxide which is excellent in prevention of electric charge injection from the conductive substrate.

The charge generating material is not particularly limited, and may be appropriately selected depending on the intended purpose. Examples thereof include azo pigments such as monoazo pigments, bisazo pigments, trisazo pigments, and tetrakis-azo pigments; organic materials such as triarylmethane dyes, thiazine dyes, oxazine dyes, xanthene dyes, cyanine dyes, styryl dyes, pyrylium dyes, quinacridone pigments, indigo pigments, perylene pigments, polycyclic quinone pigments, bisbenzimidazole pigments, indanthrone pigments, squarylium dyes, and phthalocyanine pigments; and inorganic materials such as seleniums, selenium-arsenic, selenium-tellurium, cadmium sulfides, zinc oxides, titanium oxides, and amorphous silicons. These may be used alone or in combination.

The charge transporting material is not particularly limited, and may be appropriately selected depending on the intended purpose. Examples thereof include anthracene derivatives, pyrene derivatives, carbazole derivatives, tetrazole derivatives, metallocene derivatives, phenothiazine derivatives, pyrazoline compounds, hydrazone compounds, styryl compounds, styryl hydrazone compounds, enamine compounds, butadiene compounds, distyryl compounds, oxazole compounds, oxadiazole compounds, thiazole compounds, imidazole compounds, triphenylamine derivatives, phenylenediamine derivatives, aminostilbene derivatives, and triphenylmethane derivatives. These may be used alone or in combination.

A binder resin usable for forming the photosensitive layer is not particularly limited, and may be appropriately selected depending on the intended purpose. Examples thereof include thermoplastic resins such as polyvinyl chloride, polyvinylidene chloride, vinyl chloride-vinyl acetate copolymers, vinyl chloride-vinyl acetate-maleic anhydride copolymers, ethylene-vinyl acetate copolymers, polyvinyl butyral, polyvinyl acetal, polyesters, phenoxy resins, (meth)acrylic resins, polystyrenes, polycarbonates, polyarylates, polysulfones, polyether sulfones, and ABS resins; thermosetting resins such as phenol resins, epoxy resins, urethane resins, melamine resins, isocyanate resins, alkyd resins, silicone resins, and thermosetting acrylic resins; photoconductive resins such as polyvinyl carbazoles, polyvinylanthracenes, and polyvinyl pyrenes. These may be used alone or in combination.

In each layer, a plasticizer, an antioxidant, a leveling agent may be added.

The plasticizer is not particularly limited, and may be appropriately selected depending on the intended purpose. Examples thereof include dibutyl phthalate and dioctyl phthalate. The amount of the plasticizer is normally 0% by mass to 30% by mass relative to the binder resin.

The antioxidant is not particularly limited, and may be appropriately selected depending on the intended purpose. Examples thereof include phenol compounds, such as 2,6-di-t-butyl-p-cresol, butylated hydroxyanisole, 2,6-di-t-butyl-4-ethylphenol and stearyl-β-(3,5-di-t-butyl-4-hydroxyphenyl) propionate, and 3-t-butyl-4-hydroxyanisole; bisphenol compounds such as 2,2′-methylene-bis-(4-methyl-6-t-butylphenol), 2,2′-methylene-bis-(4-ethyl-6-t-butylphenol), 4,4′-thiobis(3-methyl-6-t-butylphenol) and 4,4′-butylidenebis(3-methyl-6-t-butylphenol); polymeric phenolic compounds such as 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis (4′-hydroxy-3′-t-butylphenyl)butyric acid]glycol ester and tocophenol compounds; p-phenylenediamine compounds such as N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine and N,N′-dimethyl-N,N′-di-t-butyl-p-phenylenediamine; hydroquinones such as 2,5-di-t-octylhydroquinone, 2,6-didodecylhydroquinone, 2-dodecylhydroquinone, 2-dodecyl-5-chlorohydroquinone, 2-t-octyl-5-methylhydroquinone and 2-(2-octadecenyl)-5-methylhydroquinone; organic sulfur containing compounds such as dilauryl-3,3′-thiodipropionate, distearyl-3,3′-thiodipropionate and ditetradecyl-3,3′-thiodipropionate; and organic phosphorus-containing compounds such as triphenylphosphine, tri(nonylphenyl) phosphine, tri(dinonylphenyl)phosphine, tricresylphosphine and tri(2,4-dibutylphenoxy)phosphine. These may be used alone or in combination.

The leveling agent is not particularly limited, and may be appropriately selected depending on the intended purpose. Examples thereof include silicone oils such as dimethyl silicone oil, methylphenyl silicone oil; polymers having a perfluoroalkyl group at their side chains, or oligomers. The amount of the leveling agent is normally 0% by mass to 1% by mass relative to the binder resin.

The surface layer is provided for improving the mechanical strength, abrasion resistance, gas resistance, cleanability etc. of the photoconductor. As the surface layer, a polymer having a mechanical strength higher than the photosensitive layer, and a compound in which an inorganic filler is dispersed in the polymer are exemplified. There is no problem that the surface layer does not have charge transportability provided that it has thin thickness. However, when a surface layer having no charge transportability is formed thick, it easily cause degradation of photosensitivity of a photoconductor, an increase in potential after exposure and an increase in residual potential. Therefore, it is preferred to incorporate the above-mentioned charge transporting material into the surface layer or to use a material having charge transportability as the polymer for use in the surface layer.

As the photosensitive layer and the surface layer are greatly different from each other in their mechanical strength, the surface layer is abraded by friction against a cleaning blade, and naturally peeled off, the photoconductor is soon abraded. Therefore, when the surface layer is provided, it is important for the surface layer to have an adequate thickness. The thickness is 0.1 μm to 12 μm, preferably 1 μm to 10 μm, still more preferably 2 μm to 8 μm.

When the thickness of the surface layer is less than 0.1 μm, the surface layer tends to be partially removed because of its thin thickness, by friction with a cleaning blade, abrasion of the photosensitive layer proceeds from the removed portion. When it is more than 12 μm, degradation of photosensitivity, an increase in potential after exposure, and an increase in residual potential easily occur. Particularly when a polymer having an electric charge transportability is used, the cost of polymer having a charge transportability may be expensive.

A polymer used in the surface layer is exemplified by a polycarbonate which is transparent to wiring light used for the image formation and is superior in insulating property, mechanical strength and adhesiveness. Other than the polycarbonate, the following resins may be used. Examples of the resins include ABS resins, ACS resins, olefin-vinyl monomer copolymers, chlorinated polyether, allyl resins, phenol resins, polyacetal, polyamide, polyamideimide, polyacrylate, polyallyl sulfone, polybutylene, polybutylene terephthalate, polyether sulfone, polyethylene, polyethylene terephthalate, polyimide, acrylic resins, polymethyl benzene, polypropylene, polyphenylene oxide, polysulfone, polystyrene, AS resins, butadiene-styrene copolymers, polyurethane, polyvinyl chloride, polyvinylidene chloride, and epoxy resins. These polymers may be thermoplastic polymers, however, in order to increase the mechanical strength of the polymer, they may be crosslinked with a crosslinking agent having a polyfunctional acryloyl group, carboxyl group, hydroxyl group, amino group or the like to be thermocurable polymers. As a result, it is possible to increase the mechanical strength of the surface layer and to greatly reduce abrasion caused by friction with a cleaning blade.

In order to enhance the mechanical strength of the surface layer, metal fine particles, metal oxide fine particles (fillers) can be dispersed in the surface layer. Examples of the metal oxides include alumina, titanium oxide, tin oxide, potassium titanate, TiO₂, TiN, zinc oxide, indium oxide, antimony oxide. Moreover, for the purpose of improving abrasion resistance, fluorine resins such as polytetrafluoroethylene, silicone resins, and compounds in which inorganic material are dispersed in these resins, may be added in the surface layer.

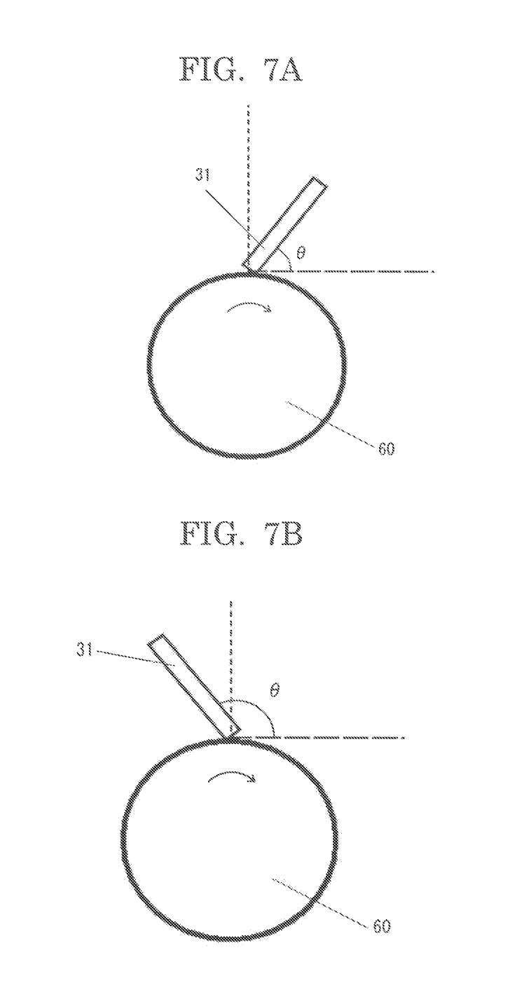

In the present invention, a blade as a protective agent layer thinning unit is preferably in contact with an image bearing member (photoconductor) at an angle for use in a counter system. In this specification, “an angle for use in a counter system” is a state that a blade is in contact with a photoconductor at an angle θ of less than 90° with respect to a rotational (travelling) direction, as shown in FIG. 7A. While, “an angle for use in a trailing (trading) system” is a state that a blade is in contact with a photoconductor at an angle θ of more than 90° with respect to a rotational (travelling) direction, as shown in FIG. 7B. The blade as the protective agent layer thinning unit preferably is brought into contact with an image bearing member at an angle for use in a counter system, since the blade prevents boron nitride from excessive adhesion to the photoconductor.

In the present invention, the blade as the protective agent layer thinning unit is preferably an obtuse angled blade (i.e. the blade having a tip in the shape of an obtuse angle). Normally, a blade having a tip in the shape of an angle of 90° has been used in terms of production efficiency. However, the obtuse angled blade is excellent as follows.

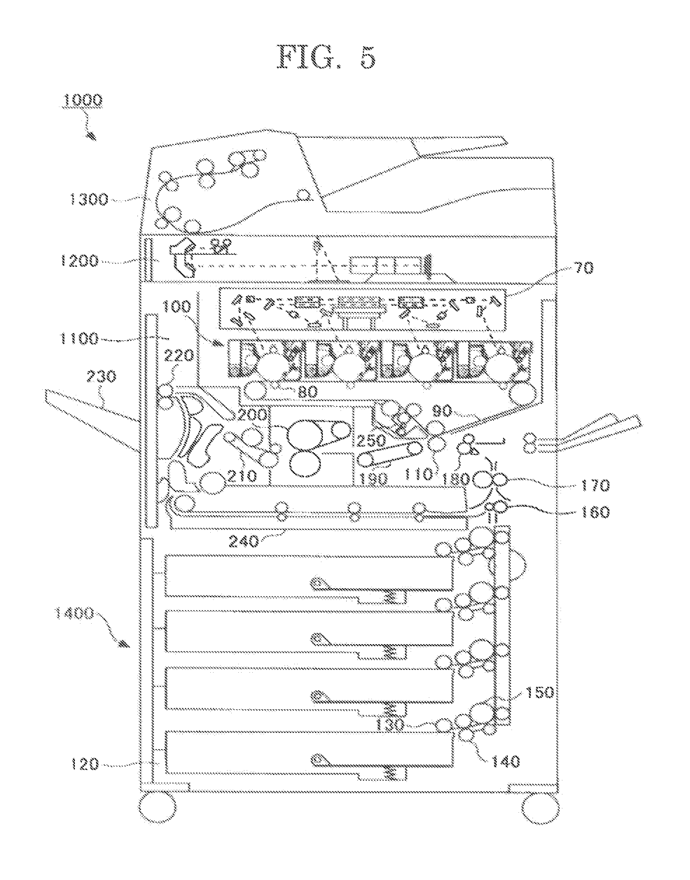

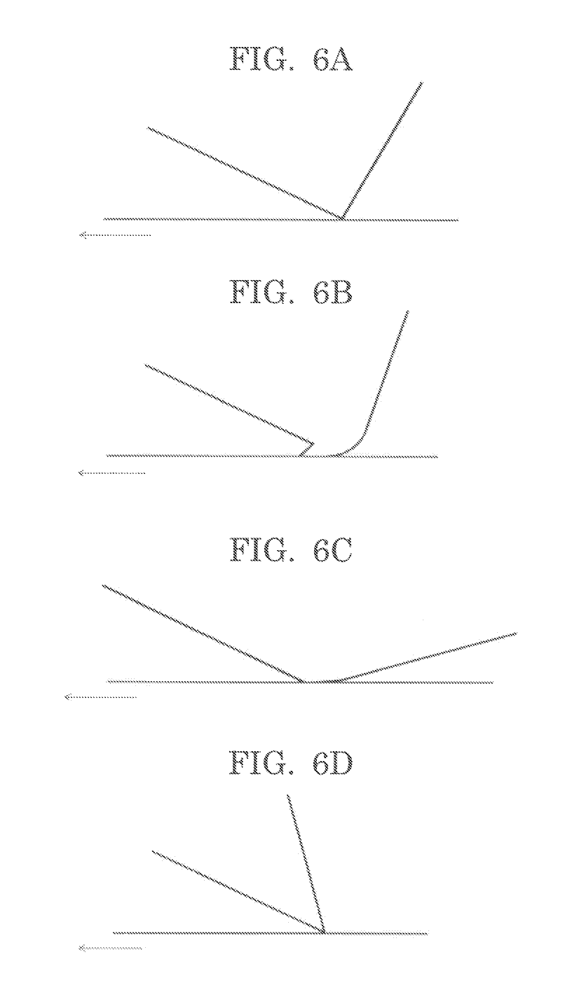

FIG. 6A is a schematic diagram showing a case where a blade tip, which is brought into contact with a photoconductor, and in the shape of a right angle (90°). As shown in FIG. 6A, in the case where the blade tip is in the shape of a right angle, the blade tip is easily drawn along the rotation of the photoconductor, and FIG. 6B is a schematic diagram showing a case where a blade tip is drawn along the rotation. However, in the case where the blade having a tip in the shape of an obtuse angle, the portion of the blade tip in contact with the photoconductor and in the shape of a large angle (FIG. 6C), and the blade tip is hardly drawn along the rotation of the photoconductor. Thus, it is considered that the blade is stably brought into contact with the photoconductor, and less vibrates, thereby improving cleanability. It is not preferred that the blade tip in the shape of a sharp angle as shown in FIG. 6D, since the blade tip is also easily drawn along the rotation of the photoconductor. In FIGS. 6A to 6D, the direction of an arrow means the rotational direction of the photoconductor.

As stated above, by using the obtuse angled blade, cleanability is improved, thereby suppressing a phenomenon that a toner, a metal soap, boron nitride etc. pass through between the photoconductor and the blade. Consequently, the obtuse angled blade suppresses boron nitride from passing through between the photoconductor and the blade, and suppresses the excessive amount of the boron nitride from adhering to the photoconductor. Moreover, the toner and the protective agent less pass through between the photoconductor and the blade, thereby suppressing the contamination of a charging roller. Therefore, the obtuse angled blade is particularly preferably used.

In the image forming apparatus of the present invention, the image bearing member may be an intermediate transfer medium, which is used for so-called image formation by intermediate transfer system, in which a toner image formed on a photoconductor is primarily transferred to superimpose colors, and further transferred to a transfer medium. The intermediate transfer medium preferably exhibits conductivity of a volume resistivity of 1×10⁵ Ω·cm to 1×10¹¹ Ω·cm. When the volume resistivity is lower than 1×10⁵ Ω·cm, it may cause so-called transfer dust where a toner image is disturbed due to electrostatic discharge caused upon transferring the toner image from a photoconductor to an intermediate transfer medium. When the volume resistivity is higher than 1×10¹¹ Ω·cm, an opposite charge to the toner image remains on the intermediate transfer medium after the toner image has been transferred from the intermediate transfer medium to a recording medium such as paper, and the opposite charge may appear as an afterimage on a subsequent image. The intermediate transfer medium preferably exhibits a surface resistivity of 1×10⁸ Ω/square to 1×10¹³ Ω/square. When the surface resistivity is lower than 1×10⁸ Ω/square, toner image may be blurred, or so-called transfer dust may be caused. When it is higher than 1×10¹³ Ω/square, it may be difficult to perform primary transfer.

As the intermediate transfer medium, for example, a belt-shaped or cylindrical plastic or the like can be used, which is formed by kneading a metal oxide such as tin oxide, and indium oxide; conductive particles such as carbon black; or a conductive polymer, alone or in combination with a thermoplastic resin, and extrusion-molding the kneaded material. Besides the above-description, it is possible to obtain an intermediate transfer belt in an endless belt form by adding the above-mentioned conductive particles and conductive polymer, if necessary, to a resin solution containing a thermally crosslinkable monomer and/or oligomer and centrifugal molding the product while heating.

When the surface layer is formed on the surface of the intermediate transfer medium, it is possible to use a surface layer prepared by additionally using a conductive material in an appropriate amount with a composition containing the above-mentioned materials used in the surface layer of the photoconductor, but excluding charge transporting materials, so as to control the resistivity.

Next, a method for forming an image using a process cartridge 100 will be described. On the surface of the photoconductor 60, from which a toner image has been transferred to a transfer medium, a partly degraded protective agent, a toner and the like remain. Thus, the surface of the photoconductor 60 is cleaned using the cleaning unit 10. To the cleaned surface of the photoconductor 60, a protective agent is applied, using the protective agent application unit 20. The surface of the photoconductor 60 coated with the protective agent is charged using a charging roller 40, and then exposed to laser beam, so as to form a latent electrostatic image. The latent electrostatic image formed on the photoconductor 60 is developed using a developing unit 50 so as to form a toner image, and then the toner image is transferred to a transfer medium.

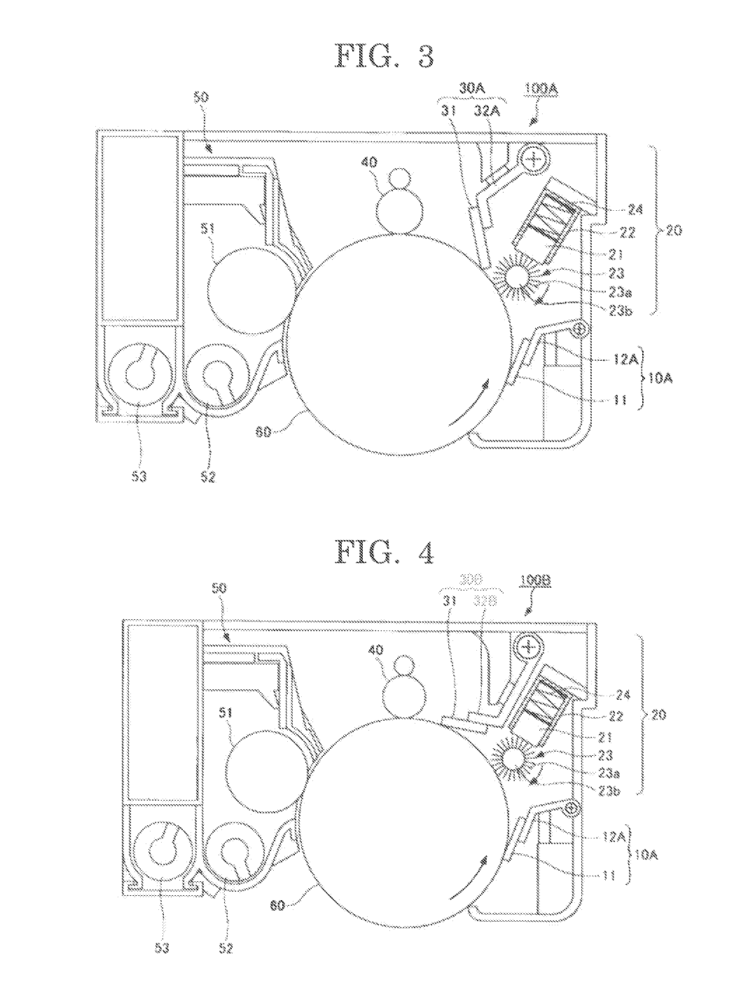

FIGS. 3 and 4 each show an example of conversion of a process cartridge 100.

In a process cartridge 100A, the pressing force mechanisms 13 and 33 are removed, and instead of the supports 12 and 32, supports 12A and 32A are provided. Namely, the process cartridge 100A has the same structure as that of the process cartridge 100, except that instead of the cleaning unit 10 and the protective agent layer thinning unit 30, a cleaning unit 10A and a protective agent layer thinning unit 30A are used.

In a process cartridge 100B, instead of the support 32A, a support 32B, which allow a blade 31 to bring into contact with a photoconductor 60 by trading system, is provided. Namely, the process cartridge 100B has the same structure as that of the process cartridge 100A, except that instead of the protective agent layer thinning unit 30A, a protective agent layer thinning unit 30B is used.

It is noted that the trading system means that the blade 31 is brought into contact with the photoconductor 60 at an angle of more than 90° with respect to the moving direction of the photoconductor 60.

FIG. 5 is a view showing an example of an image forming apparatus used in the present invention. The image forming apparatus 1000 includes an image forming section (printer section) 1100, a document reading section (scanner section) 1200 provided on the image forming section 1100, and an automatic document feeder (ADF) 1300 provided on the document reading section 1200, a paper feed section 1400 provided under the image forming section 1100, and the image forming section 1100 has a function of a copier. The image forming apparatus 1000 has a communication function with an external device, and can be used as a printer or a scanner by connecting with a personal computer, etc. outside of the apparatus. Moreover, the image forming apparatus 1000 is connected with a telephone line or an optical line so as to use as a facsimile.

In an image forming section 1100, four process cartridges 100 for forming respective toner images of yellow (Y), magenta (M), cyan (C), and black (K) are detachably mounted. Respective toner images are sequentially transferred and superimposed on an intermediate transfer belt 90 which is stretched around a plurality of rollers using a transfer roller 80, so as to form a full color toner image. At that time, photoconductors 60 of four process cartridges are exposed to laser beam emitted from an exposure unit 70 by a laser scanning system. The full color toner image formed on the intermediate transfer belt 90 is transferred to paper using a transfer roller 110.

Instead of the intermediate transfer belt 90, an intermediate transfer drum may be used.

Next, an operation of an image forming apparatus 1000 will be described. A series of process of negative-positive image formation will be described. Note that an operation of one of the process cartridges 100 will be described, since four process cartridges 100 are operated in the same manner.

A photoconductor 60 is subjected to charge elimination through a charge-eliminating lamp (not shown) or the like, and then the surface of the photoconductor 60 is uniformly negatively charged using the charging roller 40. On the charged photoconductor 60, a latent electrostatic image is formed using a laser beam irradiated from an exposure unit 70. The lease beam emitted from a light source such as a semiconductor laser is deflected by means of an optical deflector such as a polygonal column-shaped polygon mirror which rotates at high speed, and then scans a surface of the photoconductor 60 in a rotation axis direction thereof (main scanning direction) via a scanning imaging optics containing a scanning lens and a mirror. The absolute value of the potential at an exposed portion becomes lower than that of the potential at an unexposed portion.

The thus formed latent electrostatic image is developed using a developing unit 50 so as to form a toner image. When the latent electrostatic image is developed, a voltage of appropriate intensity or a developing bias obtained by superimposing an AC voltage onto the voltage is applied from a voltage applying mechanism (not shown) to a developing sleeve of the developing roller 51.

Toner images formed on the photoconductors 60 of the process cartridges 100 corresponding to respective colors are sequentially transferred and superimposed onto the intermediate transfer belt 90 using the transfer roller 80.

Paper is fed from a paper feed cassette selected from a plurality of paper feed cassettes 120 in a paper feed section 1400 by a paper feed mechanism consisting of a paper feed roller 130 and a separation roller 140, and then conveyed via a conveyance rollers 150, 160 and 170 and a registration roller 180. A full color toner image formed on the intermediate transfer belt 90 is transferred onto paper using a transfer roller 110. A transfer bias having opposite polarity to charge polarity of the toner is preferably applied to the transfer rollers 80 and 110. The paper on which the full color toner image has been transferred is conveyed using the conveyance unit 190, and fixed thereon by heat and pressure using a fixing unit 200. The paper on which the full color toner image has been fixed is delivered using a conveyance unit 210 and a delivery roller 220 to a delivery tray 230.

Moreover, the image forming apparatus 1000 has a double face printing function, upon double face printing, a conveyance path located downstream from the fixing unit 200 is switched and the paper, on which one surface the full color toner image has been fixed is reversed by a double-sided printing conveyance unit 240, and the paper is conveyed using the conveyance roller 170 and the registration roller 180. The full color toner image formed on the intermediate transfer belt 90 is transferred to the paper using the transfer roller 110. The paper on which the full color toner image is transferred is fixed thereon by heating and pressing using the fixing unit 200, and the paper is delivered to the delivery tray 230.

The toner remaining on the photoconductor 60 from which the toner image has been transferred is removed using a cleaning unit 10. The toner remaining on the intermediate transfer belt 90 from which the full color toner image has been transferred is removed using a cleaning unit 250.

In the image forming apparatus 1000, the intermediate transfer belt 90 may not be used. In this case, instead of the intermediate transfer belt 90, a transfer belt for carrying and conveying paper is used so as to sequentially transfer toner images formed on the photoconductors 60 of the process cartridges 100 corresponding to respective colors.

Next, an intermediate transfer belt 90 will be described.

The intermediate transfer belt 90 preferably has a volume resistivity of 1×10⁵ Ω·cm to 1×10¹¹ Ω·cm. When the volume resistivity is lower than 1×10⁵ Ω·cm, it may cause so-called transfer dust where a toner image is disturbed due to electrostatic discharge caused upon transferring the toner image from the photoconductor 60 to the intermediate transfer belt 90. When the volume resistivity is higher than 1×10¹¹ Ω·cm, an opposite charge to the full color toner image remains on the intermediate transfer belt 90 after the full color toner image has been transferred from the intermediate transfer belt 90 to a recording medium such as paper, and the opposite charge may appear as an afterimage on a subsequent image.

The intermediate transfer belt 90 preferably has a surface resistivity of 1×10⁸ Ω/square to 1×10¹³ Ω/square. When the surface resistivity is lower than 1×10⁸ Ω/square, toner image may be blurred, or so-called transfer dust may be caused. When it is higher than 1×10¹³ Ω/square, it may be difficult to transfer a toner image from the photoconductor 60 to the intermediate transfer belt 90.

The intermediate transfer belt 90 is not particularly limited, and those produced by the following manner can be used. Specifically, conductive particles and/or conductive polymers composed of a metal oxide (e.g. tin oxide, indium oxide), carbon black or the like are kneaded with a thermoplastic resin, and the kneaded product is subjected to extrusion-molding, or conductive particles and/or conductive polymers are added, as necessary, to a liquid containing a heat-crosslinkable monomer or oligomer, and the materials are centrifugally molded while heating.

On the intermediate transfer belt 90, a protective layer may be provided. The protective layer may be prepared by additionally using a conductive material in an appropriate amount with a composition containing the above-mentioned materials used in the protective layer of the photoconductor 60, but excluding charge transporting materials, so as to control the resistivity.

Next, a toner used in the present invention will be described.

The toner preferably has an average circularity of 0.93 to 1.00. In the present invention, a value obtained by the following Equation 1 is defined as a circularity. The circularity is an indicator of the degree of concavo-convexes, i.e., irregularity of toner particles. The closer a toner to a true sphere, the closer the circularity to 1.00. The more complicated the surface of the toner, the smaller the circularity.

Circularity SR=circumferential length of circle equal to projected area of particle/circumferential length of projected image of particle Equation 1

In the range of average circularity of 0.93 to 1.00, surfaces of toner particles are smooth, the contact area between toner particles and the contact area of toner particles with a photoconductor are small, and thus the toner is superior in transferability.

In addition, since the toner particles do not have corners, the agitation talc of the developer in a developing device is small and the drive of agitation is stabilized, abnormal images will not occur.

Also, square-cornered toner particles are not present in a toner forming dots, and thus when the toner is press-contacted with a recording medium in transfer process, the pressure is uniformly applied to the entire toner (toner particles) which forms dots. Therefore, transfer dropout hardly occurs.

Because the toner particles have no square-corner, the toner particles themselves have small frictional force and thus do not damage and do not abrade surfaces of photoconductors.

Next, a method for measuring an average circularity will be described.

The circularity can be measured using a flow type particle image analyzer, FPIA-1000 (manufactured by Sysmex Corporation) in the following manner.

Specifically, into a container from which impurity solids have been preliminarily removed, 100 mL to 150 mL of water is poured, 0.1 mL to 0.5 mL of a surfactant (preferably, alkylbenzene sulfonate) as a dispersant is added to the water, and about 0.1 g to about 0.5 g of a measurement sample is further added to the water. The suspension, in which the measurement sample is dispersed, is then subjected to a dispersion treatment by a supersonic wave dispersing machine for about 1 minute to about 3 minutes, so as to adjust the concentration of the dispersion liquid to 3,000/μl to 10,000/μl. Then, the shape of each toner particle is measured using the above-mentioned device.

In addition to the circularity, the toner used in the image forming apparatus of the present invention has a mass average particle diameter D4 of preferably 3 μm to 10 μm. Within the mass average particle diameter D4 falling in this range, the toner has toner particles which are sufficiently small to microscopic dots in a latent image, and thus the toner is superior in dot reproducibility.

When the mass average particle diameter D4 is smaller than 3 μm, phenomena of degradation of transfer efficiency and degradation of blade-cleanability easily occur. When the mass average particle diameter D4 is greater than 10 μm, it may become difficult to reduce blur of characters and lines.

A ratio (D4/D1) of the mass-average particle diameter (D4) to a number-average particle diameter (D1) is preferred to be in a range of 1.00 to 1.40. As the ratio (D4/D1) is closer to 1.00, a particle-size distribution is getting sharpened. When the toner has a ratio (D4/D1) ranging from 1.00 to 1.40, selective phenomena caused by toner diameters do not occur, and therefore it is superior in image stability.

Since the particle size distribution of the toner is sharp, the frictional charge quantity distribution also becomes sharp. As a result, it is possible to suppress the occurrence of fogging. With uniformity of toner particle diameter, the toner has excellence in the dot reproducibility because an image can be developed so that the toner particles are densely arrayed in an orderly manner with respect to dots in a latent image.

Next, a method for measuring the particle size distribution of the toner will be described.

As a particle size distribution-measuring device of toner particles by the Coulter counter method, COULTER COUNTER TA-II and COULTER COUNTER MULTISIZER II (both manufactured by Beckman Coulter Co.) are exemplified. The measurement method is described below.

Firstly, in 100 mL to 150 mL of an electrolytic solution, 0.1 mL to 5 mL of a surfactant as a dispersant (preferably, alkylbenzene sulfonate) is added. As the electrolytic solution, an approximately 1% NaCl aqueous solution is prepared using primary sodium chloride, and ISOTON-II (available from Beckman Coulter Co.) can be used. Further, 2 mg to 20 mg of a measurement sample is added to the electrolytic solution. The electrolytic solution, in which the measurement sample is suspended, is then subjected to a dispersion treatment by a supersonic wave for approximately 1 minute to approximately 3 minutes. The volume and the numbers of toner particles or a toner can be measured by the above measuring device, with use of an aperture of 100 μm, followed by calculation of a volume distribution and a number distribution. From the resulting distributions, a mass average particle diameter (D4) and a number average particle diameter (D1) can be determined.

The following 13 channels are used to measure particles having diameters of 2.00 μm or greater and smaller than 40.30 μm; a channel of 2.00 μm or greater and smaller than 2.52 μm, a channel of 2.52 μm or greater and smaller than 3.17 μm; a channel of 3.17 μm or greater and smaller than 4.00 μm; a channel of 4.00 μm or greater and smaller than 5.04 μm; a channel of 5.04 μm or greater and smaller than 6.35 μm; a channel of 6.35 μm or greater and smaller than 8.00 μm; a channel of 8.00 μm or greater and smaller than 10.08 μm; a channel of 10.08 μm or greater and smaller than 12.70 μm; a channel of 12.70 μm or greater and smaller than 16.00 μm; a channel of 16.00 μm or greater and smaller than 20.20 μm; a channel of 20.20 μm or greater and smaller than 25.40 μm; a channel of 25.40 μm or greater and smaller than 32.00 μm; and a channel of 32.00 μm or greater and smaller than 40.30 μm.

A method for producing a toner is not particularly limited and may be appropriately selected depending on the intended purpose. For example, a preferable method is that a toner material containing an isocyanate group-containing polyester prepolymer (A), amines (B), a colorant, a releasing agent, and a charge controlling agent, and optionally further containing polyester (C) is dissolved or dispersed in an organic solvent, and the obtained solution or dispersion liquid is dispersed in an aqueous medium containing resin particles, and then the isocyanate group-containing polyester prepolymer (A) is allowed to react with the amines (B), followed by removing the organic solvent. The thus obtained toner can suppress occurrence of hot-offset.

A method for stably dispersing a liquid prepared by dissolving or dispersing a toner material in an aqueous medium is not particularly limited, and may be appropriately selected depending on the intended purpose. For example, a method is exemplified in which a liquid prepared by dissolving or dispersing a toner material in an organic solvent is added in an aqueous medium and dispersed by shear force. For application of the shear force, a low-speed shear disperser, high-speed shear disperser, friction disperser, high-pressure and jet disperser, supersonic disperser, or the like may be used. Of these, the high-speed shear disperser is preferable, in order to adjust the particle diameter of the dispersion to 2 μm to 20 μm.

In the case where the high-speed shear disperser is used, the rotational speed is normally 1,000 rpm to 30,000 rpm, preferably 5,000 rpm to 20,000 rpm. The dispersing time is generally 0.1 minutes to 5 minutes in the case of batch method. The dispersing temperature is generally 0° C. to 150° C., more preferably 40° C. to 98° C., under pressure.

A liquid prepared by dissolving or dispersing the isocyanate group-containing polyester prepolymer (A) in an organic solvent, and a liquid prepared by dissolving or dispersing the toner material other than the isocyanate group-containing polyester prepolymer (A) in an organic solvent may be mixed in an aqueous medium. It is preferred that a liquid prepared by dissolving or dispersing the toner material which has been previously mixed in an organic solvent be dispersed in the aqueous medium.

A liquid prepared by dissolving or dispersing the toner material without containing the amines (B), colorant, releasing agent, and charge controlling agent in an organic solvent is dispersed in an aqueous medium, and then the amines (B), colorant, releasing agent, and charge controlling agent may be added. Specifically, a liquid prepared by dissolving or dispersing the tone material without containing the amines (B) in an organic solvent is dispersed in an aqueous medium, and then a liquid prepared by dissolving or dispersing the amines (B) in an organic solvent is added to the obtained solution or dispersion liquid, so that the amines (B) is allowed to react with the isocyanate group-containing polyester prepolymer (A). Alternatively, a liquid prepared by dissolving or dispersing the toner material without containing the colorant in an organic solvent is dispersed in an aqueous medium, and then the obtained dispersion liquid may be dyed.

The organic solvent is not particularly limited as long as it is volatile, and may be appropriately selected depending on the intended purpose.

Examples thereof include aromatic solvents such as such as toluene, xylene, benzene; halogenated hydrocarbon such as carbon tetrachloride, methylene chloride, 1,2-dichloroethane, 1,1,2-trichloroethane, trichloroethylene, chloroform, monochlorobenzene, dichloroethylidene; esters such as methyl acetate, ethyl acetate; ketones such as methyl ethyl ketone, and methyl isobutyl ketone. These may be used alone or in combination. Among these, preferred are toluene and xylem, methylene chloride, 1,2-dichloroethane, chloroform and carbon tetrachloride; and more preferred are toluene and xylene.

The amount used of the organic solvent is preferably 0 parts by mass to 300 parts by mass, more preferably 0 parts by mass to 100 parts by mass, still more preferably 25 parts by mass to 70 parts by mass, relative to 100 parts by mass of the isocyanate group-containing polyester prepolymer (A).

The aqueous medium may be composed solely of water or composed of water and an aqueous solvent. The aqueous solvent is not particularly limited and may be appropriately selected depending on the intended purpose. Examples of the aqueous solvent include alcohols such as methanol, isopropanol, ethylene glycol, etc.; dimethylformamide; tetrahydrofuran; cellosolves such as methyl cellosolve, etc.; and lower ketones such as acetone, methyl ethyl ketone, etc.

The amount of the aqueous medium is normally 50 parts by mass to 2,000 parts by mass, more preferably 100 parts by mass to 1,000 parts by mass, relative to 100 parts by mass of the toner material. When the amount of the aqueous medium is less than 50 parts by mass, a liquid in which the toner material dissolved or dispersed in an organic solvent cannot be stably dispersed, and a toner having a predetermined particle size may not be obtained. When the amount of the aqueous medium is more than 2,000 parts by mass, it is not economical.

A resin for forming the resin fine particles is not particularly limited and may be appropriately selected depending on the intended purpose. Examples thereof include vinyl resins, polyurethane resins, epoxy resins, polyester resins, polyamide resins, polyimide resins, silicon resins, phenol resins, melamine resins, urea resins, aniline resins, ionomer resins and polycarbonates. These may be used alone or in combination. Among these, vinyl resins, polyurethane resins, epoxy resins, polyesters are preferably used because fine spherical resin particles can be easily obtained.

Examples of the vinyl resin include styrene-(meth)acrylate copolymers, styrene-butadiene copolymers, (meth)acrylic acid-acrylate copolymers, styrene-acrylonitrile copolymers, styrene-maleic anhydride copolymers, and styrene-(meth)acrylic acid copolymers.

Moreover, the aqueous medium may contain a dispersant. By containing the dispersant in the aqueous medium, a liquid in which a toner material is dissolved or dispersed in an organic solvent can be stably dispersed, and a toner having narrow particle size can be obtained.

The dispersant is not particularly limited and may be appropriately selected depending on the intended purpose. Examples thereof include anionic surfactants such as alkylbenzene sulfonates, α-olefin sulfonates and phosphoric acid esters; amine salt-based cationic surfactants such as alkylamine salts, amino alcohol fatty acid derivatives, polyamine fatty acid derivatives and imidazoline; quaternary ammonium salt-based cationic surfactants such as alkyltrimethyl ammonium salts, dialkyl dimethyl ammonium salts, alkyl dimethyl benzyl ammonium salts, pyridinium salts, alkyl isoquinolinium salts and benzetonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammoniumbetaine.

As the dispersant when a fluoroalkyl group-containing surfactant is used, and it is effective in a very small amount.

Examples of fluoroalkyl group-containing anionic surfactants include fluoroalkyl carboxylic acids having 2 to 10 carbon atoms, and metal salts thereof, disodium perfluorooctanesulfonylglutamate, sodium 3-[ω-fluoroalkyl (C6 to C11) oxy]-1-alkyl (C3 to C4) sulfonate, sodium 3-[ω-fluoroalkanoyl (C6 to C8)-N-ethylamino]-1-propanesulfonate, fluoroalkyl (C11 to C20) carboxylic acids and metal salts thereof, perfluoroalkylcarboxylic acids (C7 to C13) and metal salts thereof, perfluoroalkyl (C4 to C12) sulfonic acids and metal salts thereof, perfluorooctanesulfonic acid diethanolamide, N-propyl-N-(2-hydroxyethyl)perfluorooctanesulfonamide, perfluoroalkyl (C6 to C10) sulfonamide propyltrimethylammonium salts, perfluoroalkyl (C6 to C10)-N-ethylsulfonylglycine salts and monoperfluoroalkyl (C6 to C16) ethyl phosphoric acid esters.

Examples of commercially available products of the fluoroalkyl group-containing anionic surfactants include SURFLON S-111, S-112 and S-113 (manufactured by Asahi Glass Co., Ltd.); FLUORAD FC-93, FC-95, FC-98 and FC-129 (manufactured by Sumitomo 3M Limited); UNIDYNE DS-101 and DS-102 (manufactured by DAIKIN INDUSTRIES, LTD.); MEGAFACE F-110, F-120, F-113, F-191, F-812 and F-833 (manufactured by DIC CORPORATION); EFTOP EF-102, 103, 104, 105, 112, 123A, 123B, 306A, 501, 201 and 204 (manufactured by Tochem Products Co., Ltd.); and FTERGENT F-100 and F-150 (manufactured by NEOS COMPANY LIMITED).

Examples of the fluoroalkyl group-containing cationic surfactants include fluoroalkyl group-containing aliphatic primary, secondary or tertiary amine acids, aliphatic quaternary ammonium salts such as perfluoroalkyl (C6 to C10) sulfonamide propyltrimethylammonium salts, benzalkonium salts, benzetonium chloride, pyridinium salts and imidazolinium salts.

Examples of commercially available fluoroalkyl group-containing cationic surfactants include SURFLON S-121 (manufactured by Asahi Glass Co., Ltd.), FLUORAD FC-135 (manufactured by Sumitomo 3M Limited), UNIDYNE DS-202 (manufactured by DAIKIN INDUSTRIES, LTD.), MEGAFACE F-150 and F-824 (manufactured by DIC CORPORATION), EFTOP EF-132 (manufactured by Tochem Products Co., Ltd.), and FTERGENT F-300 (manufactured by NEOS COMPANY LIMITED).

Also, as dispersants of inorganic compounds sparingly soluble in water, tricalcium phosphate, calcium carbonate, titanium oxide, colloidal silica, hydroxyappetite and the like may be used.

When calcium phosphate salt is used as the dispersant, calcium phosphate salt is dissolved in fine particles using an acid such as hydrochloric acid, and then the fine particles are washed with water, to thereby remove the calcium phosphate from the fine particles.

The aqueous medium may contain polymeric protection colloid. Examples of the polymeric protection colloid include acids such as acrylic acid, methacrylic acid, α-cyanoacrylic acid, α-cyanomethacrylic acid, itaconic acid, crotonic acid, fumaric acid, maleic acid and maleic anhydride; hydroxyl group-containing (meth)acrylic monomers such as acrylic acid β-hydroxyethyl, methacrylic acid β-hydroxyethyl, acrylic acid β-hydroxypropyl, methacrylic acid β-hydroxypropyl, acrylic acid γ-hydroxypropyl, methacrylic acid γ-hydroxypropyl, acrylic acid-3-chloro-2-hydroxypropyl, methacrylic acid-3-chloro-2-hydroxypropyl, diethyleneglycolmonoacrylic acid esters, diethyleneglycolmonomethacrylic acid esters, glycerinmonoacrylic acid esters, glycerinmonomethacrylic acid esters, N-methylolacrylamide and N-methylolmethacrylamide; vinyl alcohol and ethers of vinyl alcohol such as vinyl methyl ether, vinyl ethyl ether and vinyl propyl ether; esters of carboxyl group-containing compounds and vinyl alcohol such as vinyl acetate, vinyl propionate and vinyl butyrate; acrylamide, methacrylamide, diacetone acrylamide, and methylol compounds thereof acid chlorides such as acrylic acid chloride and methacrylic acid chloride; homopolymers and copolymers having a nitrogen atom or a heterocyclic ring having a nitrogen atom such as vinyl pyridine, vinyl pyrolidone, vinyl imidazole and ethyleneimine. Examples of the polymeric protection colloids other than the aforementioned examples include polyoxyethylenes such as polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester and polyoxyethylene nonyl phenyl ester; and celluloses such as methyl cellulose, hydroxyethyl cellulose and hydroxypropyl cellulose.

In the case where the dispersant is used, the dispersant may remain on the toner particle surface; however, it is preferred that the dispersant be removed by washing in terms of toner chargeability.

The length of time for reaction between the isocyanate group-containing polyester prepolymer (A) and the amines (B) and is normally 10 minutes to 40 hours, preferably 2 hours to 24 hours. The reaction temperature is normally 0° C. to 150° C., preferably 40° C. to 98° C. Additionally, catalysts such as dibutyltin laurate and dioctyltin laurate may be used upon reaction.

The isocyanate group-containing polyester prepolymer (A) is obtained by reaction of a hydroxyl group-containing polyester with polyisocyanate (3). The hydroxyl group-containing polyester is obtained by polycondensation of the polyol (1) with polycarboxylic acid (2).

Firstly, the polyol (1) and the polycarboxylic acid (2) are heated to 150° C. to 280° C. in the presence of an esterifying catalyst such as tetrabutoxy titanate or dibutyltin oxide, and the generated water is distilled away under reduced pressure as necessary to obtain a hydroxyl group-containing polyester. Next, the hydroxyl group-containing polyester is reacted with the polyisocyanate (3) at 40° C. to 140° C. to obtain the isocyanate group-containing polyester prepolymer (A).

The reaction of the hydroxyl group-containing polyester with the polyisocyanate (3), or the reaction of the isocyanate group-containing polyester prepolymer (A) with amines (B), may be preformed in an organic solvent if necessary. Examples of the organic solvents include aromatic solvents (toluene, xylene, etc.); ketones (acetone, methyl ethyl ketone, methyl isobutyl ketone, etc.); esters (ethyl acetate, etc.); amides (dimethylformamide, dimethylacetoamide, etc.), and solvents which are inactive to an isocyanate group, such as ethers (tetrahydrofuran, etc.).

Examples of the polyol (1) include diols (1-1) and trihydric or higher polyols (1-2), and it is preferable to use any of the diols (1-1) alone, or mixtures each composed of any of the diols (1-1) and the trihydric or higher polyols (1-2).

Examples of the diols (1-1) include alkylene glycols (ethylene glycol, 1,2-propylene glycol, 1,3-propylene glycol, 1,4-butanediol, 1,6-hexanediol, etc.); alkylene ether glycols (diethylene glycol, triethylene glycol, dipropylene glycol, polyethylene glycol, polypropylene glycol, polytetramethylene ether glycol, etc.); alicyclic diols (1,4-cyclohexanedimethanol, hydrogenated bisphenol A, etc.); bisphenols (bisphenol A, bisphenol F, bisphenol S, etc.); alkylene oxide (ethylene oxide, propylene oxide, butylene oxide, etc.) adducts of the alicyclic diols; and alkylene oxide (ethylene oxide, propylene oxide, butylene oxide, etc.) adducts of the bisphenols. Among these, preference is given to alkylene glycols having 2 to 12 carbon atoms, and alkylene oxide adducts of bisphenols, and greater preference is given to alkylene oxide adducts of bisphenols, and combinations of the alkylene oxide adducts of bisphenols and alkylene glycols having 2 to 12 carbon atoms.

Examples of the trihydric or higher polyols (1-2) include trihydric to octahydric or higher aliphatic alcohols (glycerin, trimethylolethane, trimethylolpropane, pentaerythritol, sorbitol, etc.); trihydric or higher phenols (trisphenol PA, phenol novolac, cresol novolac, etc.); and alkylene oxide adducts of the trihydric or higher phenols.

Examples of the polycarboxylic acid (2) include dicarboxylic acids (2-1) and trivalent or higher polycarboxylic acids (2-2), and it is preferable to use any of the dicarboxylic acids (2-1) alone, or mixtures each composed of any of the dicarboxylic acids (2-1) and the trivalent or higher polycarboxylic acids (2-2).

Examples of the dicarboxylic acids (2-1) include alkylene dicarboxylic acids (succinic acid, adipic acid, sebacic acid, etc.); alkenylene dicarboxylic acids (maleic acid, fumaric acid, etc.); and aromatic dicarboxylic acids (phthalic acid, isophthalic acid, terephthalic acid, naphthalenedicarboxylic acid, etc.). Among these, preference is given to alkenylene dicarboxylic acids having 4 to 20 carbon atoms and aromatic dicarboxylic acids having 8 to 20 carbon atoms.

Examples of the trivalent or higher polycarboxylic acids (2-2) include aromatic polycarboxylic acids (trimellitic acid, pyromellitic acid, etc.) having 9 to 20 carbon atoms.

Instead of the polycarboxylic acid (2), anhydrides of polycarboxylic acids (2) or lower alkyl esters (methyl ester, ethyl ester, isopropyl ester, etc.) may be used.

As for the proportion of the polyol (1) to the polycarboxylic acid (2) upon condensation polymerization, the equivalence ratio[OH]/[COOH] of the hydroxyl group[OH] to the carboxyl group[COOH] is normally in the range of 1/1 to 2/1, preferably in the range of 1/1 to 1.5/1, more preferably in the range of 1.02/1 to 1.3/1.

Examples of the polyisocyanate (3) include aliphatic polyisocyanates (tetramethylene diisocyanate, hexamethylene diisocyanate, 2,6-diisocyanatomethyl caproate, etc.); alicyclic polyisocyanates (isophorone diisocyanate, cyclohexylmethane diisocyanate, etc.); aromatic diisocyanates (tolylene diisocyanate, diphenylmethane diisocyanate, etc.); aromatic aliphatic diisocyanates (α,α,α′,α′-tetramethylxylylene diisocyanate, etc.); isocyanurates.

Instead of the polyisocyanate (3), the polyisocyanate (3) blocked with a phenol derivative, oxime, caprolactam, etc. may be used.

As for the proportion of the polyisocyanate (3) to the hydroxyl group-containing polyester, the equivalence ratio [NCO]/[OH] of the isocyanate group [NCO] to the hydroxyl group [OH] of the hydroxyl group-containing polyester is normally in the range of 1/1 to 5/1, preferably in the range of 1.2/1 to 4/1, more preferably in the range of 1.5/1 to 2.5/1. When the equivalence ratio [NCO]/[OH] is less than 1/1 in molar ratio, the amount of urea contained in the urea-modified polyester is small, adversely affecting hot offset resistance. When the equivalence ratio [NCO]/[OH] is greater than 5/1, low-temperature fixing ability may be decreased.

The amount of components of the polyisocyanate (3) contained in the isocyanate-group containing polyester prepolymer (A) is normally 0.5% by mass to 40% by mass, preferably 1% by mass to 30% by mass, more preferably 2% by mass to 20% by mass. When the amount is less than 0.5% by mass, hot offset resistance may be decreased and there is a disadvantage in satisfying both heat-resistant storage ability and low-temperature fixing ability. When the amount is greater than 40% by mass, low-temperature fixing ability may be decreased.

The number of isocyanate groups contained per molecule in the isocyanate group-containing polyester prepolymer (A) is normally 1 or more, preferably 1.5 to 3, more preferably 1.8 to 2.5. When the number of the isocyanate groups per molecule is less than 1, the molecular mass of the urea-modified polyester is low, and thus hot offset resistance may be decreased.

Examples of the amines (B) include diamines (B1), trivalent or higher polyamines (B2), amino alcohols (B3), and amino mercaptans (B4), amino acids (B5). Among these, diamines (B1) or mixtures of diamines (B1) and trivalent or higher polyamines (B2) are preferable.

Examples of the diamines (B1) include aromatic diamines such as phenylenediamine, diethyltoluenediamine, 4,4′-diaminodiphenylmethane, etc.; alicyclic diamines such as 4,4′-diamino-3,3′-dimethyldicyclohexylmethane, diaminecyclohexane, isophoronediamine, etc.; and aliphatic diamines such as ethylenediamine, tetramethylenediamine, hexamethylenediamine, etc.

Examples of the trivalent or higher polyamines (B2) include diethylenetriamine and triethylenetetramine.

Examples of the amino alcohols (B3) include ethanolamine and hydroxyethylaniline.

Examples of the amino mercaptans (B4) include aminoethyl mercaptan and aminopropyl mercaptan.

Examples of the amino acids (B5) include aminopropionic acid and aminocaproic acid.

Instead of the amines (B), ketimine compounds, in which amines (B) are blocked with ketones such as acetone, methy ethyl ketone, methyl isobutyl ketone, etc; and oxazoline compounds, in which amines (B) are blocked with aldehyde, may be used.

When the isocyanate group-containing polyester prepolymer (A) and the amines (B) are reacted, an elongation terminator may be used so as to adjust the molecular mass of the urea-modified polyester (D). Examples of the elongation terminator include monoamines such as diethylamine, dibutylamine, butylamine, laurylamine, etc., and compounds such as ketimine compounds obtained by blocking the monoamines with ketone.

As for the proportion of the isocyanate group-containing prepolymer (A) to the amines (B) upon reaction, the equivalence ratio [NCO]/[NHx] of the isocyanate group [NCO] in the isocyanate group-containing prepolymer (A) to the amino group [NHx] in the amines (B) is normally in the range of 1/2 to 2/1, preferably in the range of 2/3 to 3/2, more preferably in the range of 5/6 to 6/5. When the equivalence ratio [NCO]/[NHx] is greater than 2/1 or less than 1/2, the molecular mass of the urea-modified polyester (D) is low, and thus hot offset resistance may be decreased.

The urea-modified polyester (D) may contain a urethane bond. The equivalence ratio of the urethane bond to the urea bond is normally in the range of 0 to 9/1, preferably in the range of 1/4 to 4/1, more preferably in the range of 2/3 to 7/3. When the equivalence ratio is greater than 9/1, hot offset resistance may be decreased.

By using the urea-modified polyester (D) in combination with the polyester (C), low-temperature fixing ability is increased, and in the case of using in a full-color apparatus, glossiness is improved. The polyester (C) is obtained by polycondensation of the polyol (1) with polycarboxylic acid (2). The polyester (C) may be modified with an urethane bond.

It is desirable in terms of low-temperature fixing ability and hot offset resistance that the urea-modified polyester (D) and the polyester (C) be compatible with each other at least partially. The mass ratio of the urea-modified polyester (D) to the polyester (C) is normally 5/95 to 80/20, preferably 5/95 to 30/70, more preferably 5/95 to 25/75, particularly preferably 7/93 to 20/80. When the mass ratio is less than 5/95, hot offset resistance may decrease and there is a disadvantage in satisfying both the heat-resistant storage ability and the low-temperature fixing ability.

The peak molecular mass of the polyester (C) is normally 1,000 to 30,000, preferably 1,500 to 10,000, more preferably 2,000 to 8,000. When it is less than 1,000, heat-resistant storage ability may be decreased. When it is greater than 30,000, low-temperature fixing ability may be decreased.

The hydroxyl value of the polyester (C) is normally 5 mgKOH/g or more. It is preferably 10 mgKOH/g to 120 mgKOH/g, more preferably 20 mgKOH/g to 80 mgKOH/g. When the hydroxyl value is less than 5 mgKOH/g, there is a disadvantage in satisfying both the heat-resistant storage ability and the low-temperature fixing ability.

The acid value of the polyester (C) is normally 1 mgKOH/g to 30 mgKOH/g, preferably 5 mgKOH/g to 20 mgKOH/g. With such an acid value, the polyester (C) tends to be negatively charged.

Instead of the isocyanate group-containing prepolymer (A) and the amines (B), the urea-modified polyester (D) may be used. The urea-modified polyester (D) is obtained by reaction of the isocyanate group-containing prepolymer (A) with the amines (B) at 0° C. to 140° C.

The mass average molecular mass of the urea-modified polyester (D) is usually 10,000 or greater, and preferably 20,000 to 10,000,000, more preferably 30,000 to 1,000,000. When the mass average molecular mass is less than 10,000, hot offset resistance may be decreased.

In the case where polyester (C) is not used in combination with the urea-modified polyester (D), the number average molecular mass is normally 20,000 or less, preferably 1,000 to 10,000, more preferably 2,000 to 8,000. The number average molecular mass is more than 20,000, low-temperature fixing ability may be decreased, and in the case of using in a full-color apparatus, glossiness may be decreased. In the case where polyester (C) is used in combination, the number average molecular mass of the urea-modified polyester (D) is not particularly limited.

The glass transition point of the binder resin is normally 50° C. to 70° C., preferably 55° C. to 65° C. When it is lower than 50° C., toner blocking occurs during storage of the toner at a high temperature. When it is higher than 70° C., the low-temperature fixing ability is insufficient.

The toner containing the urea-modified polyester (D) together with the polyester (C) exhibits excellent heat resistant storage stability even when the toner has a low glass transition point.

The temperature (TG′) at which the elastic modulus of the binder resin is 10,000 dyne/cm², at a measurement frequency of 20 Hz, is normally 100° C. or higher, preferably 110° C. to 200° C. When the temperature (TG′) is lower than 100° C., hot offset resistance may be decreased.

The temperature (Tη) at which the viscosity of the binder resin is 1,000 P, at a measurement frequency of 20 Hz, is normally 180° C. or lower, preferably 90° C. to 160° C. When the temperature is higher than 180° C., low-temperature fixing ability may be decreased.

In terms of satisfying both low-temperature fixing ability and hot offset resistance, the difference between TG′ and Tη (TG′−Tη) of the binder resin is normally 0° C. or greater, preferably 10° C. or greater, more preferably 20° C. or greater. Moreover, it is desirable that the difference between Tη and Tg be preferably 0° C. to 100° C., more preferably 10° C. to 90° C., particularly preferably 20° C. to 80° C., in terms of satisfying both the heat-resistant storage ability and the low-temperature fixing ability.

The colorant is not particularly limited and may be appropriately selected depending on the intended purpose. Examples thereof include carbon black, lamp black, black iron oxide, ultramarine blue, Nigrosine dyes, aniline blue, phthalocyanine blue, phthalocyanine green, Hansa Yellow G, Rhodamine 6C Lake, Calconyl Blue, chrome yellow, quinacridone red, benzidine yellow, and rose Bengal. These may be used alone or in combination.

When a magnetic toner is produced, a magnetic component can be used as the colorant. Examples of the magnetic components include iron oxides (e.g. ferrite, magnetite, maghemite, etc.); metals (e.g. iron, cobalt, nickel, etc.), or alloys of these metals with other metals. These may be used alone or in combination.

The number average particle diameter of the colorant in the toner is normally 0.5 μm or less, preferably 0.4 μm or less, more preferably 0.3 μm or less. When number average particle diameter is greater than 0.5 μm, the transparency may not be obtained.

The colorant particles having a number average particle diameter of greater than 0.7 μm preferably occupy 10% by number or less, more preferably 5% by number or less, of all colorant particles. When it is greater than 10% by number, the colorant particles easily detach from the toner particle surface, causing problems such as fogging, contamination of a photoconductor and cleaning failure.

It is preferred that the colorant and at least one of the binder resins be kneaded with a wetting liquid. Thus, the binder resin sufficiently adheres to the colorant, and the dispersed particle size of the colorant in the toner becomes small, thereby improving transparency.

As a specific method of kneading the colorant and at least one of the binder resins with the addition of the wetting liquid, there is, for example, a method in which the colorant, the binder resin and the wetting liquid are mixed together using a blender such as a HENSCHEL MIXER, then the obtained mixture is kneaded at a temperature lower than the melting temperature of the at least one of the binder resins, using a kneading machine such as a two-roll machine or three-roll machine.

The wetting liquid is not particularly limited and may be appropriately selected depending on the intended purpose. Examples thereof include organic solvents such as acetone, toluene and butanone; and water. Among these, water is particularly preferably used in terms of the maintenance of the dispersion stability of the colorant.

The releasing agent is not particularly limited and may be appropriately selected depending on the intended purpose. Examples thereof include polyolefin waxes such as polyethylene wax, polypropylene wax, etc.; long-chain hydrocarbons such as paraffin wax, Sazol wax, etc.; and carbonyl group-containing waxes. These may be used alone or in combination. Among these, particularly preferred are carbonyl group-containing waxes.

Examples the carbonyl group-containing waxes include polyalkanoic acid esters such as carnauba wax, montan wax, trimethylolpropane tribehenate, pentaerythritol tetrabehenate, pentaerythritol diacetate dibehenate, glycerin tribehenate, 1,18-octadecanediol distearate, etc.; polyalkanol esters such as tristearyl trimellitate, distearyl maleate, etc; polyalkanoic acid amides such as ethylenediamine dibehenyl amide, etc.; polyalkylamides such as trimellitic acid tristearyl amide, etc.; and dialkyl ketones such as distearyl ketone, etc. These may be used alone or in combination. Among these, polyalkanoic acid esters are particularly preferable.

The melting point of the releasing agent is normally 40° C. to 160° C., preferably 50° C. to 120° C., more preferably 60° C. to 90° C. The releasing agent having a melting point of lower than 40° C. may adversely affect heat-resistant storage ability, and the releasing agent having a melting point of higher than 160° C. is likely to cause cold offset when toner is fixed at a low temperature.

The melt viscosity of the releasing agent is preferably 5 cps to 1,000 cps, more preferably 10 cps to 100 cps, when measured at a temperature higher than the melting point of the releasing agent by 20° C. When the releasing agent has a melt viscosity higher than 1,000 cps, hot offset resistance and low temperature fixing ability may be decreased.

The amount of the releasing agent contained in the toner is normally 0% by mass to 40% by mass, preferably 3% by mass to 30% by mass.

The charge controlling agent is not particularly limited and may be appropriately selected depending on the intended purpose. Examples thereof include triphenylmethane dyes, molybdic acid chelate pigments, rhodamine dyes, alkoxy amines, quaternary ammonium salts (including fluorine-modified quaternary ammonium salts), alkylamides, phosphorus and compounds thereof, tungsten and compounds thereof, fluorine surfactants, metal salts of salicylic acid and metal salts of salicylic acid derivatives, quinacridone, and azo pigments. Additionally, as the charge controlling agent other than those described above, polymeric compounds containing functional groups such as sulfonic acid group, carboxyl group and quaternary ammonium salt are exemplified.

Examples of the commercially available charge controlling agent include BONTRON P-51 as a quaternary ammonium salt, E-82 as an oxynaphthoic acid metal complex, E-84 as a salicylic acid metal complex, and E-89 as a phenolic condensate (manufactured by Orient Chemical Industries); TP-302 and TP-415 as quaternary ammonium salt molybdenum complexes (manufactured by Hodogaya Chemical Industries); COPY CHARGE PSY VP2038 as a quaternary ammonium salt, COPY BLUE PR as a triphenylmethane derivative, and COPY CHARGE NEG VP2036 and COPY CHARGE NX VP434 as quaternary ammonium salts (manufactured by Hoechst); LRA-901, and LR-147 as a boron complex (manufactured by Japan Carlit Co., Ltd.).

The amount of the charge controlling agent in the toner is normally 0.1% by mass to 10% by mass, preferably 0.2% by mass to 5% by mass, relative to the binder resin. When the amount of the charge controlling agent is greater than 10% by mass, there is an increase in electrostatic suction toward a developing roller, causing a decrease in the fluidity of a developer and a decrease in image density.

The charge controlling agent may be dissolved or dispersed in an organic solvent after kneaded together with part of the binder resin.

In order to remove the organic solvent, a method can be used in which the temperature of a reaction liquid is gradually increased to completely evaporate and remove the organic solvent in the reaction liquid. Alternatively, the reaction liquid may be sprayed in a dry atmosphere so as to remove the organic solvent. When the reaction liquid is sprayed in a dry atmosphere, a spray dryer, a belt dryer or a rotary kiln, or the like can be used. As the dry atmosphere, air flow of gas heated to a temperature equal to or higher than the boiling point of the organic solvent is used, and examples of the gas include air, nitrogen, carbon dioxide gas, and combustion gas.

After the organic solvent is removed, classification may be performed. Fine particles can be removed by means of a cyclone, a decanter, a centrifugal separator or the like. At that time powder obtained by drying may be classified.

The toner base particles thus obtained is mixed with other particles, such as the colorant, releasing agent, charge controlling agent, fluidizer, cleaning improver, etc., and the mixture may be subjected to mechanical impact to fix the particles at the surface. Specifically, there are provided a method of applying mechanical impact to the mixture using a blade that rotates at high speed; and a method of throwing the mixture into a high speed gas flow so that the mixture is accelerated and collided with a collision plate. As apparatuses for implementing the methods, provided are Angmill (manufactured by Hosokawa Micron Corporation) and I-type mill (manufactured by Nippon Pneumatic Mfg. Co., Ltd.) that are adapted to drop air pressure for milling, Hybridization System (manufactured by Nara Machinery Co., Ltd.), Kryptron System (manufactured by Kawasaki Heavy Industries, Ltd.), and an automatic mortar, etc.

The fluidizer is not particularly limited, and may be appropriately selected depending on the intended purpose. Examples thereof include inorganic particles such as silica, alumina, titanium oxide, barium titanate, magnesium titanate, calcium titanate, strontium titanate, zinc oxide, tin oxide, silica sand, clay, mica, wollastonite, diatom earth, chrome oxide, cerium oxide, red ochre, antimony trioxide, magnesium oxide, zirconium oxide, barium sulfate, barium carbonate, calcium carbonate, silicon carbide and silicon nitride; resin fine particles such as polystylene, copolymers of methyl(meth)acrylate, silicone resins, benzoguanamine, and nylon.

The average primary particle diameter of the fluidizer is normally 5 nm to 2,000 nm, preferably 5 nm to 500 nm.

The BET specific surface area of the fluidizer is preferably 20 m²/g to 500 m²/g.

The amount of the fluidizer in the toner is normally 0.01% by mass to 5% by mass, preferably 0.01% by mass to 2.0% by mass.

The inorganic fine particles are not particularly limited and may be appropriately selected depending on the intended purpose. The inorganic fine particles are preferably subjected to surface treatment using a surface treatment agent. Examples of the surface treatment agent include silane coupling agents, silylation agents, silane coupling agents having a fluoroalkyl group, organic titanate-based coupling agents, aluminum-based coupling agents, silicone oils, and modified silicone oils. Thus, the decrease of fluidity and chargeability of the toner at high humidity can be prevented.

A cleaning improver is not particularly limited and may be appropriately selected depending on the intended purpose. Examples thereof include fatty acid metal salts such as zinc stearate, calcium stearate; and resin particles such as polymethyl methacrylate particles and polystyrene particles.

The volume average particle diameter of the resin particles is normally 0.01 μm to 1 μm.

As the toner, a pulverized toner may be used.

A method for producing the pulverized toner is exemplified by a method in which the toner material containing the binder resin, the colorant, the releasing agent, and the charge controlling agent is mixed as necessary, and kneaded at a temperature equal to or lower than a melting temperature of the binder resin, followed by cooling, pulverizing, and classifying.

The binder resin is not particularly limited and may be appropriately selected depending on the intended purpose. Examples thereof include homopolymers of styrene and its substitution polymers, such as polystyrene, poly-p-chlorostyrene and polyvinyl toluene; styrene copolymers such as styrene-p-chlorostyrene copolymers, styrene-propylene copolymers, styrene-vinyl toluene copolymers, styrene-vinyl naphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-methyl chlormethacrylate copolymers, styrene-acrylonitrile copolymers, styrene-vinyl methyl ketone copolymers, styrene-butadiene copolymers, styrene-isoprene copolymers and styrene-maleic acid copolymers; homopolymers and copolymers of acrylic acid esters, such as polymethyl acrylate, polybutyl acrylate, polymethyl methacrylate and polybutyl methacrylate; polyvinyl derivatives such as polyvinyl chloride and polyvinyl acetate; polyester polymers, polyurethane polymers, polyamide polymers, polyimide polymers, polyol polymers, epoxy polymers, terpene polymers, aliphatic or alicyclic hydrocarbon resins and aromatic petroleum resins. These may be used alone or in combination. Among these, styrene-acrylic copolymer resins, polyester resins and polyol resins are more preferably used in terms of electrical property, and the like. The polyester resins and/or polyol resins are still more preferably used because of their excellent toner-fixing properties.

### EXAMPLES

Hereinafter, Examples of the present invention will be specifically described along with Comparative Examples. However, it should be noted that the present invention is not confined to these Examples in any way. It should be noted that in the following examples, the unit “part(s) means “part(s) by mass” and the unit “%” means “% by mass” unless otherwise specified.

### Production of Toner

### —Preparation of Resin Particle Dispersion Liquid—

In a reaction vessel equipped with a stirring rod and a thermometer, 683 parts of water, 11 parts of a sodium salt of sulfate ester of ethylene oxide adduct of methacrylic acid (ELEMINOL RS-30 manufactured by Sanyo Chemical Industries, Ltd.), 79 parts of styrene, 79 parts of methacrylic acid, 105 parts of butyl acrylate, 13 parts of divinylbenzene and 1 part of ammonium persulfate were charged, and stirred at 400 rpm for 15 minutes to obtain a white emulsion. This emulsion was heated to a temperature of 75° C. and reacted for 5 hours. Next, 30 parts of a 1% aqueous ammonium persulfate solution was added to the reaction vessel and aged at 75° C. for 5 hours to obtain a Resin Particle Dispersion Liquid 1. The mass average particle diameter of Resin Particle Dispersion Liquid 1 was measured using a particle size distribution analyzer (“LA-920” manufactured by HORIBA, Ltd.) and found to be 105 nm. In addition, a part of Resin Particle Dispersion Liquid 1 was dried to isolate a resin component. This resin component had a glass transition point of 95° C., a number average molecular mass of 140,000 and a mass average molecular mass of 980,000.

In a reaction vessel equipped with a stirring rod and a thermometer, 683 parts of water, 11 parts of a sodium salt of sulfate ester of ethylene oxide adduct of methacrylic acid (ELEMINOL RS-30 manufactured by Sanyo Chemical Industries, Ltd.), 83 parts of styrene, 83 parts of methacrylic acid, 110 parts of butyl acrylate, and 1 part of ammonium persulfate were charged, and stirred at 400 rpm for 15 minutes to obtain a white emulsion. This emulsion was heated to a temperature of 75° C. and reacted for 5 hours. Next, 30 parts of a 1% aqueous ammonium persulfate solution was added thereto and aged at 75° C. for 5 hours to obtain a Resin Particle Dispersion Liquid 2. The mass average particle diameter of Resin Particle Dispersion Liquid 2 was measured using a particle size distribution analyzer (“LA-920” manufactured by HORIBA, Ltd.) and found to be 100 nm. In addition, a part of Resin Particle Dispersion Liquid 2 was dried to isolate a resin component. This resin component had a glass transition point of 80° C., a number average molecular mass of 1,700 and a mass average molecular mass of 10,000.

### —Synthesis of Polyester—

In a reaction vessel equipped with a cooling tube, a stirrer, and a nitrogen introducing tube, 220 parts of an ethylene oxide 2-mol adduct of bisphenol A, 561 parts of a propylene oxide 3-mol adduct of bisphenol A, 218 parts of terephthalic acid, 48 parts of adipic acid, and 2 parts of dibutyltin oxide were charged and reacted at 230° C. for 8 hours and further reacted at 10 mmHg to 15 mmHg for 5 hours, then 45 parts of trimellitic anhydride was charged in the reaction vessel, and the mixture was reacted at 180° C. for 2 hours to obtain Polyester 1. The obtained Polyester 1 had a number average molecular mass of 2,500, a mass average molecular mass of 6,700, a glass transition point of 43° C., and an acid value of 25 mgKOH/g.

### —Synthesis of Polyester Prepolymer—

In a reaction vessel equipped with a cooling tube, a stirrer, and a nitrogen introducing tube, 682 parts of ethylene oxide 2-mol adduct of bisphenol A, 81 parts of a propylene oxide 2-mol adduct of bisphenol A, 283 parts of terephthalic acid, 22 parts of trimellitic anhydride, and 2 parts of dibutyltin oxide were charged and reacted at 230° C. for 8 hours, and further reacted at 10 mmHg to 15 mmHg for 5 hours to obtain hydroxyl group-containing polyester. The hydroxyl group-containing polyester had a number average molecular mass of 2,100, a mass average molecular mass of 9,500, a glass transition point of 55° C., an acid value of 0.5 mgKOH/g and a hydroxyl value of 49 mgKOH/g.

Next, in a reaction vessel equipped with a cooling tube, a stirrer, and a nitrogen introducing tube, 411 parts of the hydroxyl group-containing polyester, 89 parts of isophorone diisocyanate, and 500 parts of ethyl acetate were charged and reacted at 100° C. for 5 hours to obtain Polyester Prepolymer 1.

The obtained Polyester Prepolymer 1 had a free isocyanate content of 1.53%.

### —Synthesis of Ketimine—

In a reaction vessel equipped with a stirring rod and a thermometer, 170 parts of isophoronediamine and 75 parts of methyl ethyl ketone were charged and reacted at 50° C. for 5 hours to obtain Ketimine 1. The obtained Ketimine 1 had an amine value of 418 mgKOH/g.

### —Preparation of Master Batch—

Carbon black (REGAL 400R, manufactured by Cabot Corporation) (40 parts), 60 parts of a polyester resin (RS-801, manufactured by Sanyo Chemical Industries, Ltd., an acid value of 10 mgKOH/g, a mass average molecular mass of 20,000 and a glass transition point of 64° C.), and 30 parts of water were mixed by using a HENSCHEL MIXER. The obtained mixture was kneaded for 45 minutes by using a two-roll mill whose surface temperature was adjusted to 130° C., and pulverized with a pulverizer (manufactured by Hosokawa Micron Corporation), so that the pulverized material had a diameter of 1 mm, to thereby obtain Master Batch 1.

### —Preparation of Toner Material—

In a reaction vessel equipped with a stirring rod and a thermometer, 378 parts of Polyester 1, 110 parts of carnauba wax, 22 parts of a salicylic acid metal complex (E-84, manufactured by Orient Chemical Industries), and 947 parts of ethyl acetate were charged and stirred while the temperature was increased to 80° C., and maintained for 5 hours, and then rapidly cooled to 30° C. for 1 hour. Next, 500 parts of Master Batch 1 and 500 parts of ethyl acetate were added to the reaction vessel and mixed for 1 hour. The mixed liquid (1,324 parts) was charged in a vessel, and dispersed using a bead mill (ULTRAVISCOMILL manufactured by Aimex Co., Ltd.) which was filled with 80% by volume of zirconia beads each having a diameter of 0.5 mm under the conditions of a liquid feeding speed of 1 kg/hr, a disk circumferential speed of 6 m/sec., and 3 times-pass through. Next, 1,324 parts of a 65% of ethyl acetate solution of Polyester 1 was added to the mixed liquid, and then passed through the bead mill (ULTRAVISCOMILL manufactured by Aimex Co., Ltd.) 1 time under the above-described conditions to obtain a dispersion liquid. The dispersion liquid had a solid content concentration of 50% (130° C., 30 minutes).

In a vessel 648 parts of the obtained dispersion liquid, 154 parts of Polyester Prepolymer 1, and 6.6 parts of Ketimine 1 were charged and mixed using a TK homomixer (manufactured by PRIMIX Corporation) at 5,000 rpm for 1 minute, to thereby obtain Toner Material Liquid 1.

### —Preparation of Slurry—

In a vessel 990 parts of water, 8 parts of Resin Particle Dispersion Liquid 1, 72 parts of Resin Particle Dispersion Liquid 2, 40 parts of a 48.5% aqueous solution of sodium dodecyl diphenyl ether disulfonate (ELEMINOL MON-7, manufactured by Sanyo Chemical Industries, Ltd.), and 90 parts of ethyl acetate were charged and mixed using the TK homomixer (manufactured by PRIMIX Corporation) at 3,000 rpm for 1 minute. Next, 809 parts of Toner Material Liquid 1 was added to the vessel, and then mixed using the TK homomixer (manufactured by PRIMIX Corporation) at 13,000 rpm for 20 minutes. In a vessel equipped with a stirrer and a thermometer, the mixed liquid was charged and a solvent was removed from the mixed liquid at 30° C. for 8 hours and aged at 45° C. for 4 hours to obtain Slurry 1.

### —Washing, Drying, Classifying—

Slurry 1 (100 parts) were filtered under reduced pressure. Next, 300 parts of ion exchanged water was added to the resulting filter cake, and mixed at 12,000 rpm for 10 minutes using the TK homomixer, followed by a filtration treatment. This treatment was performed three times. The resulting filter cake was dried with a circular air-drier at 45° C. for 48 hours and sieved with a mesh with openings of 75 to thereby obtain Base Particles 1.

### —Addition of Fluidizer—

To Base Particles 1 silica, which had been surface treated using hexamethyldisilazane having an average particle diameter of 12 nm, was added so that the amount of the silica became 2.0% in toner, and mixed for 2 minutes using a HENSCHEL MIXER (manufactured by NIPPON COKE & ENGINEERING CO., LTD.), to thereby obtain a toner. Using FPIA-2100 (manufactured by SYSMEX CORPORATION), a particle size distribution of the toner was measured. The toner had a mass average particle diameter of 5.30 μm, a number average particle diameter of 4.65 μm, and an average circularity of 0.97.

### Production of Photoconductor

Onto an aluminum drum (conductive substrate) having an outer diameter of 40 mm, a coating liquid for an undercoat layer, which contained 6 parts of an alkyd resin (BECKOSOL 1307-60-EL, manufactured by DIC CORPORATION), 4 parts of a melamine resin (SUPER BECKAMINE G-821-60, manufactured by DIC CORPORATION), 40 parts of titanium oxide, and 200 parts of methyl ethyl ketone, was applied by immersion, and then dried to form an undercoat layer having a thickness of 3.6 μm.

Next, onto the conductive substrate on which the undercoat layer was formed, a coating liquid for a charge generating layer, which contained 2 parts of a Y-type oxotitanyl phthalocyanine pigment, 0.2 parts of polyvinyl butyral (S-LEC BM-S, manufactured by SEKISUI CHEMICAL CO., LTD.), and 50 parts of tetrahydrofuran, was applied by immersion, and then dried to form a charge generating layer having a thickness of 0.14 μm.

Moreover, onto the conductive substrate on which the undercoat layer and the charge generating layer were formed, a coating liquid for a charge transporting layer, which contained 10 parts of bisphenol A polycarbonate resin (PANLITE K1300, manufactured by Teijin Chemicals Ltd.), 10 parts of a charge transport material A represented by the following structural formula, and 100 parts of methylene chloride, was applied by immersion, and then dried to form a charge transporting layer having a thickness of 23 μm.

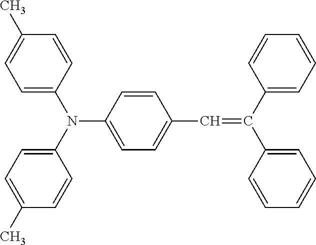

Finally, onto the conductive substrate on which the undercoat layer, the charge generating layer and the charge transporting layer were formed, a coating liquid for a protective layer, which contained 10 parts of polycarbonate, 7 parts of the charge transport material A represented by the above structural formula, 4 parts of alumina particles having an average particle diameter of 0.30 μm, 0.08 parts of a dispersing agent (BYK-P104, manufactured by BYK Chemie Japan), 700 parts of tetrahydrofuran and 200 parts of cyclohexanone, was applied by spraying, and then dried to form a protective layer having a thickness of 3.5 μm. Thus, a photoconductor was produced.

A protective sheet was fixed to the photoconductor with an adhesive tape, in a state that an area where the photosensitive layer formed on the photoconductor was covered with the protective sheet, onto which surface facing the photoconductor a lubricant adhered, and then a photoconductor was stored for 20 hours. Thereafter, the protective sheet was removed from the photoconductor, and the photoconductor was started to use.

### Production of Protective Sheet A1

Using a finely-woven fabric which wrapped boron nitride particles having an average particle diameter of 5 μm, a surface of black lightproof paper containing dispersed carbon black and having a thickness of 100 μm was tapped, so as to obtain Protective Sheet A1 to which a lubricant adhered in an average adhesion amount of 0.028 mg/cm².

### Production of Protective Sheet A2

Using a finely-woven which fabric wrapped boron nitride particles having an average particle diameter of 10 μm, a surface of black lightproof paper containing dispersed carbon black and having a thickness of 100 μm was tapped, so as to obtain Protective Sheet A2 to which a lubricant adhered in an average adhesion amount of 0.033 mg/cm².

### Production of Protective Sheet A3

Using a finely-woven fabric which wrapped a powder mixture of a metal soap containing zinc stearate particles having an average particle diameter of 17 μm and zinc palmitate particles having an average particle diameter of 17 μm (a mass ratio of the zinc stearate and the zinc palmitate was 71:29), and boron nitride particles having an average particle diameter of 5 μm, a surface of black lightproof paper containing dispersed carbon black and having a thickness of 100 μm was tapped, so as to obtain Protective Sheet A3 to which a lubricant adhered in an average adhesion amount of 0.11 mg/cm². Using ICP Optical Emission Spectrometer (SPS5100, manufactured by SII NanoTechnology Inc.) Protective Sheet A3 was analyzed, and it was found that the mass ratio of the metal soap and the boron nitride was 65:35.

The powder mixture was obtained in such a manner that a power of a mixture of the metal soap and the boron nitride was placed in an aluminum metal mold having an internal size of 8 mm×350 mm, and then pressurized with an oil hydraulic press to compress the mixture powder to 95% of the true specific gravity, so as to obtain a bar having a size of 7 mm×8 mm×350 mm, followed by pulverizing the bar.

### Production of Protective Sheet A4

Using a finely-woven fabric which wrapped a powder mixture of a metal soap containing zinc stearate particles having an average particle diameter of 17 μm and zinc palmitate particles having an average particle diameter of 17 μm (a mass ratio of the zinc stearate and the zinc palmitate was 68:32), and boron nitride particles having an average particle diameter of 3 μm, a surface of black lightproof paper containing dispersed carbon black and having a thickness of 100 μm was tapped, so as to obtain Protective Sheet A4 to which a lubricant adhered in an average adhesion amount of 0.10 mg/cm². Using ICP Optical Emission Spectrometer (SPS5100, manufactured by SII NanoTechnology Inc.) Protective Sheet A4 was analyzed, and it was found that the mass ratio of the metal soap and the boron nitride was 35:65.

The powder mixture was obtained in such a manner that a power of a mixture of the metal soap and the boron nitride was placed in an aluminum metal mold having an internal size of 8 mm×350 mm, and then pressurized with the oil hydraulic press to compress the mixture powder to 95% of the true specific gravity, so as to obtain a bar having a size of 7 mm×8 mm×350 mm, followed by pulverizing the bar.

### Production of Protective Sheet A5

Using a finely-woven fabric which wrapped a powder mixture of a metal soap containing zinc stearate particles having an average particle diameter of 17 μm and zinc palmitate particles having an average particle diameter of 17 μm (a mass ratio of the zinc stearate and the zinc palmitate was 68:32), and boron nitride particles having an average particle diameter of 10 μm, a surface of black lightproof paper containing dispersed carbon black and having a thickness of 100 μm was tapped, so as to obtain Protective Sheet A5 to which a lubricant adhered in an average adhesion amount of 0.25 mg/cm². Using ICP Optical Emission Spectrometer (SPS5100, manufactured by SII NanoTechnology Inc.) Protective Sheet A5 was analyzed, and it was found that the mass ratio of the metal soap and the boron nitride was 91:9.

The powder mixture was obtained in such a manner that a power of a mixture of the metal soap and the boron nitride was placed in an aluminum metal mold having an internal size of 8 mm×350 mm, and then pressurized with the oil hydraulic press to compress the mixture powder to 95% of the true specific gravity, so as to obtain a bar having a size of 7 mm×8 mm×350 mm, followed by pulverizing the bar.

### Production of Protective Sheet A6

Using a finely-woven fabric which wrapped a powder of a metal soap containing zinc stearate particles having an average particle diameter of 17 μm and zinc palmitate particles having an average particle diameter of 17 μm (a mass ratio of the zinc stearate and the zinc palmitate was 55:45), a surface of black lightproof paper containing dispersed carbon black and having a thickness of 100 μm was tapped, so as to obtain Protective Sheet A6 to which a lubricant adhered in an average adhesion amount of 0.20 mg/cm².

The powder was obtained in such a manner that a power of the metal soap was placed in an aluminum metal mold having an internal size of 8 mm×350 mm, and then pressurized with the oil hydraulic press to compress the powder to 95% of the true specific gravity, so as to obtain a bar having a size of 7 mm×8 mm×350 mm, followed by pulverizing the bar.

### Production of Protective Sheet A7

Using a finely-woven fabric which wrapped polymethyl methacrylate particles having an average particle diameter of 0.4 μm, a surface of black lightproof paper containing dispersed carbon black and having a thickness of 100 μm was tapped, so as to obtain Protective Sheet A7 to which a lubricant adhered in an average adhesion amount of 0.20 mg/cm².

### Production of Protective Sheet A8

Using a finely-woven fabric which wrapped a powder mixture of a metal soap containing zinc stearate particles having an average particle diameter of 17 μm and zinc palmitate particles having an average particle diameter of 17 μm (a mass ratio of the zinc stearate and the zinc palmitate was 68:32), and boron nitride particles having an average particle diameter of 5 μm, a surface of black lightproof paper containing dispersed carbon black and having a thickness of 100 μm was tapped, so as to obtain Protective Sheet A8 to which a lubricant adhered in an average adhesion amount of 1.6 mg/cm². Using ICP Optical Emission Spectrometer (SPS5100, manufactured by SII NanoTechnology Inc.) Protective Sheet A8 was analyzed, and it was found that the mass ratio of the metal soap and the boron nitride was 40:60.

The powder mixture was obtained in such a manner that a power of a mixture of the metal soap and the boron nitride was placed in an aluminum metal mold having an internal size of 8 mm×350 mm, and then pressurized with the oil hydraulic press to compress the mixture powder to 95% of the true specific gravity, so as to obtain a bar having a size of 7 mm×8 mm×350 mm, followed by pulverizing the bar.

### Production of Protective Agent Bar A1

Powder of a metal soap containing zinc stearate particles having an average particle diameter of 17 μm and zinc palmitate particles having an average particle diameter of 17 μm (a mass ratio of the zinc stearate and the zinc palmitate was 55:45) was placed in an aluminum metal mold having an internal size of 8 mm×350 mm, and then pressurized with the oil hydraulic press to compress the mixture powder to 95% of the true specific gravity, so as to obtain a bar having a size of 7 mm×8 mm×350 mm. The both ends of the produced protective agent bar in the longitudinal direction were cut out, and then the bottom face thereof was cut out, so as to produce Protective Agent Bar A1 having a size of 7 mm×8 mm×310 mm. On the bottom face of Protective Agent Bar A1 a double faced tape was affixed, and then Protective Agent Bar A1 was fixed to a metallic substrate.

### Production of Protective Agent Bar A2

Protective Agent Bar A2 was produced in the same manner as in the production of Protective Agent Bar A1, except that the powder of the metal soap was changed to powder of a mixture of a metal soap and boron nitride particles, where the metal soap contained zinc stearate particles having an average particle diameter of 17 μm and zinc palmitate particles having an average particle diameter of 17 μm (a mass ratio of the zinc stearate and the zinc palmitate was 66:34), and the boron nitride particles had an average particle diameter of 5 μm (a mass ratio of the metal soap and the boron nitride was 95:5).

### Production of Protective Agent Bar A3

Protective Agent Bar A3 was produced in the same manner as in the production of Protective Agent Bar A1, except that the powder of the metal soap was changed to powder of a mixture of a metal soap and boron nitride particles, where the metal soap contained zinc stearate particles having an average particle diameter of 17 μm and zinc palmitate particles having an average particle diameter of 17 μm (a mass ratio of the zinc stearate and the zinc palmitate was 69:31), and the boron nitride particles had an average particle diameter of 5 μm (a mass ratio of the metal soap and the boron nitride was 95:5).

### Production of Protective Agent Bar A4

Protective Agent Bar A4 was produced in the same manner as in the production of Protective Agent Bar A1, except that the powder of the metal soap was changed to powder of a mixture of a metal soap and boron nitride particles, where the metal soap contained zinc stearate particles having an average particle diameter of 17 μm and zinc palmitate particles having an average particle diameter of 17 μm (a mass ratio of the zinc stearate and the zinc palmitate was 43:57), and the boron nitride particles had an average particle diameter of 5 μm (a mass ratio of the metal soap and the boron nitride was 70:30), and that the amount of the spherical alumina particles having an average particle diameter of 0.3 μm added was 4% relative to the amount of the metal soap.

### Production of Protective Agent Bar A5

Protective Agent Bar A5 was produced in the same manner as in the production of Protective Agent Bar A1, except that the powder of the metal soap was changed to powder of a mixture of a metal soap and boron nitride particles, where the metal soap contained zinc stearate particles having an average particle diameter of 17 μm and zinc palmitate particles having an average particle diameter of 17 μm (a mass ratio of the zinc stearate and the zinc palmitate was 50:50), and the boron nitride particles had an average particle diameter of 5 μm (a mass ratio of the metal soap and the boron nitride was 65:35), and that the amount of the spherical alumina particles having an average particle diameter of 0.3 μm added was 4% relative to the amount of the metal soap.

### Example A1

A tandem color image forming apparatus (IMAGIO MPC4500, manufactured by Ricoh Company, Ltd.) was used, and in the image forming apparatus a plurality of process cartridges 100A (see FIG. 3) were mounted, in each of the process cartridges 100A as a cleaning blade 11 an urethane blade having a tip, which was brought into contact with the photoconductor 60, and in the shape of a right angle was used, as a blade 31 an urethane blade having a tip, which was brought into contact with the photoconductor 60, and in the shape of an obtuse angle was used, and a protective agent application unit 20 was not used. As a protective sheet, Protective Sheet A1 was used. Next, the linear velocity of the photoconductor 60 was set to 140 mm/sec, and a superimposed voltage obtained by superimposing an alternating voltage with an amplitude of 1,100 V and a frequency of 1,450 Hz to a direct voltage of −600 V was applied to the photoconductor 60 using a charging roller 40, and an ISO test chart (see, a home page of ISO/IEC JTC 1/SC 28, http://www.iso.org/jtc1/sc 28) in accordance with JIS X 6932 was printed out in a low temperature and low humidity environment (room temperature of 15° C. and 30% RH).

Images of 5,000th and 10,000th sheets were visually observed, and images with high quality were formed. Moreover, the images of the 5,000th and 10,000th sheets were observed with a microscope, and uniform dots were aligned therein. After the 5,000 sheets of the ISO test chart were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Example A2

The ISO test chart was printed out in the same manner as in Example A1, except that the conditions were changed as follows: the protective agent application unit 20 was used, as the protective agent bar 21 Protective Agent Bar A3 was used, as the brush roller 23 Brush Roller 1 formed by spirally winding a tape made of a pile-woven fabric formed of fibers 23a around a metal core 23b, in which fibers 23a each having 5.3 denier-thick and 3 mm-long were pile-woven in a base fabric in a density of 5×10⁴ fibers per square inch was used, and a spring pressure for press contacting the protective agent bar 21 against the brush roller 23 was set to 3.2 N.

Images of 5,000th and 10,000th sheets were visually observed, and it was confirmed that images with high quality were formed. Moreover, the images of the 5,000th and 10,000th sheets were observed under the microscope, and in the image of the 5,000th sheet uniform dots were aligned. In the image of the 10,000th sheet, the density of dots was slightly varied, compared to those in the image of the 5,000th sheet. After the 5,000 sheets of the ISO test chart were printed out, powder adhering to the blade 31 was scraped out with a spatula, and analyzed using the ICP Optical Emission Spectrometer (SPS5100, manufactured by SIT NanoTechnology Inc.), and then boron was detected. Thus, it was found that boron nitride was present on the blade 31.

### Example A3

The ISO test chart was printed out in the same manner as in Example A1, except that the conditions were changed as follows: the protective agent application unit 20 was used, as the protective agent bar 21 Protective Agent Bar A1 was used, as the brush roller 23 Brush Roller 2 formed by planting on a metal core 23b fibers each having 10 denier-thick and 3 mm-long in a density of 5×10⁴ fibers per square inch was used, a spring pressure for press contacting the protective agent bar 21 against the brush roller 23 was set to 4.0 N, and as the protective sheet Protective Sheet A3 was used.

Images of 5,000th and 10,000th sheets were visually observed, and it was confirmed that images with high quality were formed. Moreover, the images of the 5,000th and 10,000th sheets were observed under the microscope, and uniform dots were aligned therein. After the 5,000 sheets of the ISO test chart were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Example A4

The ISO test chart was printed out in the same manner as in Example A1, except that the conditions were changed as follows: the protective agent application unit 20 was used, as the protective agent bar 21 Protective Agent Bar A4 was used, as the brush roller 23 Brush Roller 3 formed by spirally winding a tape made of a pile-woven fabric formed of fibers 23a around a metal core 23b, in which fibers 23a each having 20 denier-thick and 3 mm-long were pile-woven in a base fabric in a density of 5×10⁴ fibers per square inch was used, a spring pressure for press contacting the protective agent bar 21 against the brush roller 23 was set to 3.8 N, and as the protective sheet Protective Sheet A4 was used.

Images of 5,000th and 10,000th sheets were visually observed, and it was confirmed that images with high quality were formed. Moreover, the images of the 5,000th and 10,000th sheets were observed under the microscope, and uniform dots were aligned therein. After the 5,000 sheets of the ISO test chart were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Example A5

The ISO test chart was printed out in the same manner as in Example A1, except that the conditions were changed as follows: the protective agent application unit 20 was used, as the protective agent bar 21 Protective Agent Bar A2 was used, as the brush roller 23 Brush Roller 2 was used, a spring pressure for press contacting the protective agent bar 21 against the brush roller 23 was set to 5.5 N, and as the protective sheet Protective Sheet A5 was used.

Images of 5,000th, 10,000th and 50,000th sheets were visually observed, and it was confirmed that images with high quality were formed. Moreover, the images of the 5,000th, 10,000th and 50,000th sheets were observed under the microscope, and in the image of the 5,000th sheet uniform dots were aligned. In the images of the 10,000th and 50,000th sheets, the density of dots was slightly varied, compared to those in the image of the 5,000th sheet. After the 5,000 sheets of the ISO test chart were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Example A6

The ISO test chart was printed out in the same manner as in Example A1, except that the conditions were changed as follows: the protective agent application unit 20 was used, as the protective agent bar 21 Protective Agent Bar A5 was used, as the brush roller 23 Brush Roller 2 was used, a spring pressure for press contacting the protective agent bar 21 against the brush roller 23 was set to 3.8 N, and as the protective sheet Protective Sheet A2 was used.

Images of 5,000th, 10,000th and 50,000th sheets were visually observed, and it was confirmed that images with high quality were formed. Moreover, the images of the 5,000th, 10,000th and 50,000th sheets were observed under the microscope, and the sizes of the dots in the images of the 5,000th, 10,000th, and 50,000th sheets were wider than those in the image of the 5,000th sheet of Example A1 observed under the microscope. After 5,000 sheets were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Example A7

The ISO test chart was printed out in the same manner as in Example A1, except that the conditions were changed as follows: the protective agent application unit 20 was used, as the protective agent bar 21 Protective Agent Bar A1 was used, as the brush roller 23 Brush Roller 3 was used, a spring pressure for press contacting the protective agent bar 21 against the brush roller 23 was set to 6.8 N, and as the protective sheet Protective Sheet A1 was used.

Images of 5,000th and 10,000th sheets were visually observed, and it was confirmed that images with high quality were formed. Moreover, the images of the 5,000th and 10,000th sheets were observed under the microscope, and uniform dots were aligned therein. After the 5,000 sheets of the ISO test chart were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Example A8

The ISO test chart was printed out in the same manner as in Example A1, except that the conditions were changed as follows: the protective agent application unit 20 was used, as the protective agent bar 21 Protective Agent Bar A1 was used, as the brush roller 23 Brush Roller 2 was used, a spring pressure for press contacting the protective agent bar 21 against the brush roller 23 was set to 5.5 N, and as the protective sheet Protective Sheet A1 was used.

Images of 5,000th and 10,000th sheets were visually observed, and it was confirmed that images with high quality were formed. Moreover, the images of the 5,000th and 10,000th sheets were observed under the microscope, and uniform dots were aligned therein. After the 5,000 sheets of the ISO test chart were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Example A9

The ISO test chart was printed out in the same manner as in Example A1, except that the conditions were changed as follows: the protective agent application unit 20 was used, as the protective agent bar 21 Protective Agent Bar A 1 was used, as the brush roller 23 Brush Roller 2 was used, a spring pressure for press contacting the protective agent bar 21 against the brush roller 23 was set to 6.8 N, and as the protective sheet Protective Sheet A8 was used.

Images of 5,000th and 10,000th sheets were visually observed, and it was confirmed that images with high quality were formed. Moreover, the images of the 5,000th and 10,000th sheets were observed under the microscope, and uniform dots were aligned therein. After the 5,000 sheets of the ISO test chart were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Example A10

The ISO test chart was printed out in the same manner as in Example A1, except that as the protective sheet Protective Sheet A8 was used.

Images of 5,000th and 10,000th sheets were visually observed, and it was confirmed that images with high quality were formed. Moreover, the images of the 5,000th and 10,000th sheets were observed under the microscope, and uniform dots were aligned therein. After the 5,000 sheets of the ISO test chart were printed out, powder adhering to the blade 31 was scraped out with a spatula, and analyzed using the ICP Optical Emission Spectrometer (SPS5100, manufactured by SII NanoTechnology Inc.), and then boron was detected. Thus, it was found that boron nitride was present on the blade 31.

### Comparative Example A1

The ISO test chart was printed out in the same manner as in Example A1, except that the conditions were changed as follows: the protective agent application unit 20 was used, as the protective agent bar 21 Protective Agent Bar A1 was used, as the brush roller 23 Brush Roller 2 was used, a spring pressure for press contacting the protective agent bar 21 against the brush roller 23 was set to 4.5 N, and as the protective sheet black lightproof paper containing dispersed carbon black and having a thickness of 100 μm was used.

Images of 5,000th, 10,000th and 50,000th sheets were visually observed, and it was confirmed that on the 5,000th and 10,000th sheets images with high quality were formed. However, in the images of the 50,000th sheet streaky defects were slightly observed. Moreover, the images of the 5,000th, and 10,000th sheets were observed under the microscope, and the density of dots in the images of the 5,000th, and 10,000th sheets was varied in the greater extent, compared to those in the image of the 5,000th sheet of Example A1 observed under the microscope. After the 5,000 sheets of the ISO test chart were printed out, KBr was added to the powder adhering to the blade 31 and then scraped out with a spatula. Thereafter, a tablet was formed from the scraped powder, and analyzed using FT/IR6100 (manufactured by JASCO Corporation), and then a peak derived from a metal soap was detected. Thus, it was found that the metal soap was present on the blade 31.

### Comparative Example A2

The ISO test chart was printed out in the same manner as in Example A1, except that as the protective sheet Protective Sheet A6 was used.

Images of 5,000th and 10,000th sheets were visually observed, and it was confirmed that black lines were formed thereon. After the 5,000 sheets of the ISO test chart were printed out, KBr was added to the powder adhering to the blade 31 and then scraped out with a spatula. Thereafter, a tablet was formed from the scraped powder, and analyzed using FT/IR6100 (manufactured by JASCO Corporation), and then a peak derived from a metal soap was not detected. Thus, it was found that metal soap was not present on the blade 31.

### Comparative Example A3

The ISO test chart was printed out in the same manner as in Example A1, except that the conditions were changed as follows: the protective agent application unit 20 was used, as the protective agent bar 21 Protective Agent Bar A1 was used, as the brush roller 23 Brush Roller 3 was used, a spring pressure for press contacting the protective agent bar 21 against the brush roller 23 was set to 4.5 N, and as the protective sheet Protective Sheet A7 was used.

Images of 5,000th and 10,000th sheets were visually observed, and it was confirmed that on the 5,000th sheet the image with high quality was formed. However, on the 10,000th sheet streaky defects were slightly observed in the image, and background smear was also observed. Moreover, the image of the 5,000th sheet was observed under the microscope, and the density of the dots was varied in the greater extent and background smear was observed thereon, compared to those in the image of the 5,000th sheet of Example A1 observed under the microscope. After the 5,000 sheets of the ISO test chart were printed out, KBr was added to the powder adhering to the blade 31 and then scraped out with a spatula. Thereafter, a tablet was formed from the scraped powder, and analyzed using FT/IR6100 (manufactured by JASCO Corporation), and then a peak derived from polymethyl methacrylate was not detected. Thus, it was found that polymethyl methacrylate was not present on the blade 31.

Photoconductors B1 to B13 respectively used in Examples B1 to B10 and Comparative Examples B1 to B3 were produced as follows.

### (Photoconductor)

Onto an aluminum drum (conductive substrate) having an outer diameter of 40 mm, coating liquids for an undercoat layer, a charge generating layer, a charge transporting layer and a surface layer were applied in this order and dried to produce a photoconductor on which the undercoat layer, the charge generating layer, the charge transporting layer and the surface layer were formed. The undercoat layer had a thickness of 3.6 μm, the charge generating layer had a thickness of 0.14 μm, the charge transporting layer had a thickness of 23 μm, and the surface layer had a thickness of 3.5 μm. The surface layer was applied by spraying, and the other layers were applied by immersion. The coating liquids of respective layers were specified as follows.

[Coating Liquid for Undercoat layer]

| | |
|---|---|
| Alkyd resin (BECKOSOL 1307-60-EL, manufactured | 6 parts |
| by DIC CORPORATION) | |
| Melamine resin (SUPER BECKAMINE G-821-60, | 4 parts |
| manufactured by DIC CORPORATION) | |
| Titanium oxide | 40 parts |
| Methyl ethyl ketone | 200 parts |

[Coating Liquid for Charge Generating Layer]

| | |
|---|---|
| Y-type oxotitanyl phthalocyanine pigment | 2 parts |
| Polyvinyl butyral (S-LEC BM-S, manufactured | 0.2 parts |
| by SEKISUI CHEMICAL CO., LTD.) | |
| Tetrahydrofuran | 50 parts |

| | |
|---|---|
| [Coating Liquid for Charge Generating Layer] | |
| Bisphenol A polycarbonate resin (PANLITE K1300, | 10 parts |
| manufactured by Teijin Chemicals Ltd.) | |
| Low-molecular charge transport material represented by the | 10 parts |
| following Structural Formula 1 | |
| 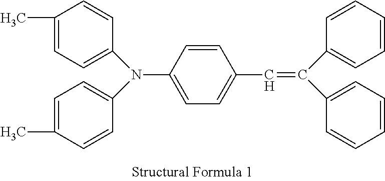 | |
| Methylene chloride | 100 parts |

[Coating Liquid for Surface Layer]

| | |
|---|---|
| Polycarbonate | 10 parts |
| Low-molecular charge transport material represented by the | 7 parts |
| following Structural Formula 1 | |
| 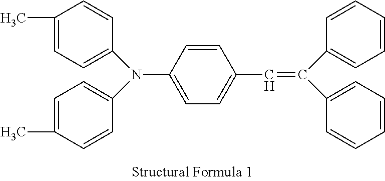 | |
| Alumina fine particles having an average particle diameter | 6 parts |
| of 0.30 μm | |
| Dispersing agent (BYK-P104, manufactured by BYK Chemie | 0.08 parts |
| Japan) | |
| Tetrahydrofuran | 700 parts |
| Cyclohexanone | 200 parts |

The protective agent bars used were produced as follows. Production Method of Protective Agent Bar B1 (a mixture consisting of zinc stearate and zinc palmitate)

Powder of a mixture of zinc stearate and zinc palmitate was placed in an aluminum metal mold having an internal size of 8 mm×350 mm, and then pressurized with an oil hydraulic press to compress the mixture powder to 95% of the true specific gravity, so as to obtain a bar having a thickness of 7 mm.

The both ends of the produced protective agent bar in the longitudinal direction were cut out, and then the bottom face thereof was cut out, so as to produce Protective Agent Bar B1 having a size of 7 mm×8 mm×310 mm. On the bottom face of Protective Agent Bar B1 a double faced tape was affixed, and then Protective Agent Bar B1 was fixed to a metallic substrate.

### Production Method of Protective Agent Bars B2 and B3 (Containing Boron Nitride)

To a mixture of zinc stearate and zinc palmitate, boron nitride was added so that the amount of the boron nitride became 3% in the mixture, followed by mixing and stirring. The resultant mixture powder was placed in an aluminum metal mold having an internal size of 8 mm×350 mm, and then pressurized with the oil hydraulic press to compress the mixture powder to 95% of the true specific gravity, so as to obtain a bar having a thickness of 7 mm. Note that the mixture ratio of the zinc stearate and the zinc palmitate was varied between Protective Agent Bar B2 and Protective Agent Bar B3.

The both ends of the produced protective agent bar in the longitudinal direction were cut out, and then the bottom face thereof was cut out, so as to produce each of Protective Agent Bars B2 and B3 having a size of 7 mm×8 mm×310 mm. On the bottom face of each Protective Agent Bar B2 and B3 a double faced tape was affixed, and then each Protective Agents Bar B2 and B3 was fixed to a metallic substrate. Production Method of Protective Agent Bars B4 and B5 (containing boron nitride and alumina)

To a mixture of zinc stearate and zinc palmitate, powders of boron nitride and spherical alumina particles having an average particle diameter of 0.3 μm were added, followed by mixing and stirring. The resultant mixture powder was placed in an aluminum metal mold having an internal size of 8 mm×350 mm, and then pressurized with the oil hydraulic press to compress the mixture powder to 95% of the true specific gravity, so as to obtain a bar having a thickness of 7 mm. Note that the mixture ratio of the zinc stearate and the zinc palmitate was varied between Protective Agent Bar B4 and Protective Agent Bar B5.

The both ends of the produced protective agent bar in the longitudinal direction were cut out, and then the bottom face thereof was cut out, so as to produce each of Protective Agent Bars B4 and B5 having a size of 7 mm×8 mm×310 mm. On the bottom face of each Protective Agent Bars B4 and B5 a double faced tape was affixed, and then each Protective Agent Bar B4 and B5 was fixed to a metallic substrate.

In Table B1, the mixture ratios (mass ratios) of zinc stearate and zinc palmitate, the mixture ratios (mass ratios) of the metal soap (the zinc stearate and the zinc palmitate) and boron nitride (BN), and the proportions (% by mass) of alumina to the metal soap are shown.

TABLE B1

| | Mass ratio of zinc stearate | | | Proportion of |
|---|---|---|---|---|
| Protec- | and zinc palmitate in | | Mass ratio of | alumina to a |
| tive | metal soap (% by mass) | | metal soap and | mass of metal |
| Agent | zinc | zinc | BN | soap |
| Bar | stearate | palmitate | (metal soap/BN) | (% by mass) |
| B1 | 55 | 45 | — | — |
| B2 | 66 | 34 | 97/3 | — |
| B3 | 69 | 31 | 97/3 | — |
| B4 | 40 | 60 | 70/30 | 4 |
| B5 | 50 | 50 | 65/35 | 4 |

As a blade, an urethane blade was used.

After the photoconductor was produced, the photoconductor was covered with a protective sheet as described below. In these Examples, black lightproof paper containing carbon black was used as the protective sheet for the photoconductor. The photoconductor was left to stand for 1 day or longer with the surface thereof covered with the protective sheet. When the evaluation was performed, the protective sheet was removed from the photoconductor, and then the photoconductor was mounted in an apparatus.

Photoconductors B1, B2, B6, B10, B11 with Boron Nitride

A finely-woven fabric by which boron nitride was wrapped was tapped on the protective sheet, so that the powder of the boron nitride adhered to a surface thereof facing the photoconductor. Then, each of Photoconductors B1, B2, B6, B10, B11 was covered with the protective sheet.

The adhered amount of boron nitride on the black lightproof paper (protective sheet) was 0.3 mg/cm².

Photoconductors B3, B4, B5, B12, B13 with Mixture of Boron Nitride, Zinc Stearate and Zinc Palmitate

A mixture of boron nitride, zinc stearate, and zinc palmitate was sufficiently stirred, once pressed using the oil hydraulic press, to obtain a molded bar. A production method of a bar was the same as those of Protective Agent Bars B2 and B3. The molded bar was pulverized into powder, and the powder, i.e. a lubricant mixture was wrapped in a finely-woven fabric. The finely-woven fabric was tapped on the protective sheet, so that the powder adhered to a surface thereof facing the photoconductor. Then, each of Photoconductors B3, B4, B5, B12, B13 was covered with the protective sheet.

The pulverized powder was analyzed using an ICP Optical Emission Spectrometer (SPS5100, manufactured by SII NanoTechnology Inc.). The ratio of the mixture of the metal soap containing the zinc stearate and the zinc palmitate, to the boron nitride, which adhered to the surface of the protective sheet facing each of Photoconductors B3, B4, B5, B12, B13, was respectively as follows: the ratio of metal soap to boron nitride (metal soap/boron nitride)=70/30 (Photoconductor B3), 40/60 (Photoconductor B4), 91/9 (Photoconductor B5), 40/60 (Photoconductor B12), 40/60 (Photoconductor B13).

Photoconductor B7 with No Application

Nothing was applied to the protective sheet, and Photoconductor B7 was covered with the protective sheet.

Photoconductor B8 with Metal Soap

A finely-woven fabric by which a metal soap (i.e. powder obtained by pulverizing Protective Agent Bar B1) was wrapped was tapped on the protective sheet, so that the powder of the metal soap adhered to a surface thereof facing the photoconductor. Then, Photoconductor B8 was covered with the protective sheet.

Photoconductor B9 with PMMA

A finely-woven fabric by which polymethyl methacrylate (PMMA) was wrapped was tapped on the protective sheet, so that the PMMA adhered to a surface thereof facing the photoconductor. Then, Photoconductor B9 was covered with the protective sheet.

In Table B2, the materials applied to the black paper, the mixture ratios (mass ratios) of the metal soap and the boron nitride (BN) are shown.

TABLE B2

| | Material applied to | Ratio of metal soap and BN |
|---|---|---|
| Photoconductor | black paper | (metal soap/BN) |
| B1 | BN | — |
| B2 | BN | — |
| B3 | BN + metal soap | 70/30 |
| B4 | BN + metal soap | 40/60 |
| B5 | BN + metal soap | 91/9 |
| B6 | BN | — |
| B7 | Not applied | — |
| B8 | metal soap | — |
| B9 | PMMA | — |
| B10 | BN | — |
| B11 | BN | — |
| B12 | BN + metal soap | 40/60 |
| B13 | BN + metal soap | 40/60 |

### <Evaluation>

For evaluation, as shown in FIG. 5, a tandem color image forming apparatus (IMAGIO MPC4500, manufactured by Ricoh Company, Ltd.) including a plurality of image formation sections (process cartridges) each equipped with a protective agent application unit was used. A blade for applying a protective agent installed in the apparatus was replaced with a counter blade having a tip in the shape of an obtuse angle. The linear velocity of the photoconductor was set to 125 mm/sec, and a superimposed voltage obtained by superimposing an alternating voltage with an amplitude of 1,100 V and a frequency of 1,450 Hz to a direct voltage of −600 V was applied to between the photoconductor and a charging roller. The evaluation was performed in a low temperature and low humidity environment (room temperature of 15° C. and 30% RH). A toner used was the same as the toner used in Examples A1 to A9 and Comparative Examples A1 to A3.

As a chart for evaluation, an ISO test chart (see, a home page of ISO/IEC JTC 1/SC 28, http://www.iso.org/jtc1/sc28) was used. After 5,000 sheets of the ISO test chart were printed out, powder adhering to the blade was carefully scraped out with a spatula, and analyzed by an ICP Optical Emission Spectroscopy, and FR-IR analysis, and then the presence or absence of boron nitride, a metal soap or PMMA adhered on each of blades of Examples B1 to B10 and Comparative Examples B2 and B3 after printing was evaluated. In order to perform the ICP optical emission spectroscopy, a certain amount or more of the power to be scraped was needed. Thus, under the same conditions, images were printed out plural times to collect a sample for the ICP optical emission spectroscopy. As to the FR-IR analysis, in the same manner as the ICP optical emission spectroscopy, under the same conditions images were printed out plural times, and the blade used for printing out the images was coated with KBr powder. The applied KBr powder was collected again, and all of the collected powder was formed into a tablet as a sample for the analysis, and then the analysis was performed. The presence or absence of boron nitride was judged from the emission of boron in the ICP optical emission spectroscopy, and the presence or absence of the metal soap and PMMA was judged from an IR peak.

### Example B1

Using the photoconductor shown in Table B3, 5,000 sheets of the ISO test chart were printed out. An image of 5,000th sheet was visually observed, and it was confirmed that the image with high quality was formed. Thereafter, further 5,000 sheets of the ISO test chart were printed out. An image of 10,000th sheet was visually observed, and it was confirmed that the image with high quality was formed.

### Example B2

Under the conditions of the photoconductor, protective agent bar, brush roller, spring pressure for press contacting the protective agent bar against the brush roller shown in Table B3, 5,000 sheets of the ISO test chart were printed out. An image of 5,000th sheet was visually observed, and it was confirmed that the image with high quality was formed. Thereafter, further 5,000 sheets of the ISO test chart were printed out. An image of 10,000th sheet was visually observed, and it was confirmed that the image with high quality was formed.

### Example B3

Under the conditions of the photoconductor, protective agent bar, brush roller, spring pressure for press contacting the protective agent bar against the brush roller shown in Table B3, 5,000 sheets of the ISO test chart were printed out. An image of 5,000th sheet was visually observed, and it was confirmed that the image with high quality was formed. Thereafter, further 5,000 sheets of the ISO test chart were printed out. An image of 10,000th sheet was visually observed, and it was confirmed that the image with high quality was formed. The images of the 10,000th sheets of Examples B1, B2 and B3 were observed with a microscope, and compared each other. In the images of the 10,000th sheets of Examples B1 and B3, uniform dots were aligned. However, in the image of the 10,000th sheet of Example B2, the density of dots was slightly varied. Again, the images of the 5,000th sheets and the 10,000th sheets of Examples B1, B2 and B3 were visually observed and compared each other, no significant difference was observed.

### Example B4

Under the conditions of the photoconductor, protective agent bar, brush roller, spring pressure for press contacting the protective agent bar against the brush roller shown in Table B3, 5,000 sheets of the ISO test chart were printed out. An image of 5,000th sheet was visually observed, and it was confirmed that the image with high quality was formed. Thereafter, further 5,000 sheets of the ISO test chart were printed out. An image of 10,000th sheet was visually observed, and it was confirmed that the image with high quality was formed.

### Example B5

Under the conditions of the photoconductor, protective agent bar, brush roller, spring pressure for press contacting the protective agent bar against the brush roller shown in Table B3, 5,000 sheets of the ISO test chart were printed out. An image of 5,000th sheet was visually observed, and it was confirmed that the image with high quality was formed. Thereafter, further 5,000 sheets of the ISO test chart were printed out. An image of 10,000th sheet was visually observed, and it was confirmed that the image with high quality was formed.

### Example B6

Under the conditions of the photoconductor, protective agent bar, brush roller, spring pressure for press contacting the protective agent bar against the brush roller shown in Table B3, 5,000 sheets of the ISO test chart were printed out. An image of 5,000th sheet was visually observed, and it was confirmed that the image with high quality was formed. Thereafter, further 5,000 sheets of the ISO test chart were printed out. An image of 10,000th sheet was visually observed, and it was confirmed that the image with high quality was formed. The images of the 10,000th sheets of Examples B4, B5 and B6 were observed under the microscope, and compared each other. In the image of the 10,000th sheet of Example B4, uniform dots were aligned. However, in the image of the 10,000th sheet of Example B5, the density of dots was slightly varied. In the image of the 10,000th sheet of Example B6, the sizes of the dots were somewhat wider. Again, the images of the 5,000th sheets and the 10,000th sheets of Examples B4 to B6 were visually observed and compared each other, and as a result no significant difference was observed.

The images of the 5,000th sheets of Examples B1 to B6 were observed under the microscope, and compared each other. In the image of the 5,000th sheets of Examples B1 to B5, uniform dots were aligned. However, in the image of the 5,000th sheet of Example B6, the sizes of the dots were somewhat wider. Again, the images of the 5,000th sheets of Examples B1 to B6 were visually observed and compared each other, and as a result no significant difference was observed.

### Example B7

Under the conditions of the photoconductor, protective agent bar, brush roller, spring pressure for press contacting the protective agent bar against the brush roller shown in Table B3, 5,000 sheets of the ISO test chart were printed out. An image of the 5,000th sheet was visually observed, and it was confirmed that the image with high quality was formed. Thereafter, further 5,000 sheets of the ISO test chart were printed out. An image of the 10,000th sheet was visually observed, and it was confirmed that the image with high quality was formed.

### Example B8

Under the conditions of the photoconductor, protective agent bar, brush roller, spring pressure for press contacting the protective agent bar against the brush roller shown in Table B3, 5,000 sheets of the ISO test chart were printed out. An image of the 5,000th sheet was visually observed, and it was confirmed that the image with high quality was formed. Thereafter, further 5,000 sheets of the ISO test chart were printed out. An image of the 10,000th sheet was visually observed, and it was confirmed that the image with high quality was formed.

### Example B9

Under the conditions of the photoconductor, protective agent bar, brush roller, spring pressure for press contacting the protective agent bar against the brush roller shown in Table B3, 5,000 sheets of the ISO test chart were printed out. An image of the 5,000th sheet was visually observed, and it was confirmed that the image with high quality was formed. Thereafter, further 5,000 sheets of the ISO test chart were printed out. An image of the 10,000th sheet was visually observed, and it was confirmed that the image with high quality was formed.

### Example B10

Under the conditions of the photoconductor shown in Table B3, 5,000 sheets of the ISO test chart were printed out. An image of the 5,000th sheet was visually observed, and it was confirmed that the image with high quality was formed. Thereafter, further 5,000 sheets of the ISO test chart were printed out. An image of the 10,000th sheet was visually observed, and it was confirmed that the image with high quality was formed.

The images of the 5,000th and 10,000th sheets of Examples B7 to B10 were observed under the microscope, and compared each other. In all images uniform dots were aligned.

### Comparative Example B1

Under the conditions of the photoconductor, protective agent bar, brush roller, spring pressure for press contacting the protective agent bar against the brush roller shown in Table B3, 5,000 sheets of the ISO test chart were printed out. An image of the 5,000th sheet was visually observed, and it was confirmed that the image with high quality was formed. Thereafter, further 5,000 sheets of the ISO test chart were printed out. An image of the 10,000th sheet was visually observed, and it was confirmed that the image with high quality was formed.

### Comparative Example B2

Under the conditions of the photoconductor shown in Table B3, 5,000 sheets of the ISO test chart were printed out. An image of the 5,000th sheet was visually observed, and it was confirmed that black lines were slightly formed. Thereafter, further 5,000 sheets of the ISO test chart were printed out. An image of the 10,000th sheet was visually observed, and it was confirmed that black lines were formed, similar to that of the 5,000th sheet.

### Comparative Example B3

Under the conditions of the photoconductor, protective agent bar, brush roller, spring pressure for press contacting the protective agent bar against the brush roller shown in Table B3, 5,000 sheets of the ISO test chart were printed out. An image of the 5,000th sheet was visually observed, and it was confirmed that the image with high quality was formed. Thereafter, further 5,000 sheets of the ISO test chart were printed out. An image of the 10,000th sheet was visually observed, and it was confirmed that streaky defects were slightly caused in the image, and light background smear was also observed. Moreover, the image appeared to have image noise.

Moreover, the images of the 5,000th sheets of Comparative Examples B1 and B3, and the image of the 10,000th sheet of Comparative Example B1 were observed under the microscope. Comparing the image of the 5,000th sheet and the image of the 10,000th sheet in Comparative B1 or B3 with the corresponding images in any of Examples B1 to B4, the density of dots in the images of the 5,000th and 10,000th sheets of Comparative Example B1 was varied, and in the image of the 5,000th of Comparative Example B3 the density of dots was varied, and background smear was more severe than that in the images of other Examples (Examples B1 to B4). Again, the images of Comparative Examples B1, B3 and Examples B1 to B4 were compared by visual observation. There was no significant difference therebetween.

Under the conditions of Examples B5 and B6 and Comparative Example B1, further 40,000 sheets of the ISO test chart were printed out. In total, 50,000 sheets of the ISO test chart were printed out. The image of the 50,000th sheet was visually observed. The image under the conditions of Examples B5 and B6 maintained high quality. On the images printed out under the conditions of Comparative Example B1, streaky defects were slightly observed.

Next, the photoconductors, the protective agent bars, the brush rollers, the spring pressures for press contacting the protective agent bars against the brush rollers, the linear velocities, the evaluation results are shown in Table B3.

TABLE B3

| | | | | | | | | Presence or | | | |
|---|---|---|---|---|---|---|---|---|---|---|---|
| | | | | | | | | absence of | | | |
| | | | | | The | | | lubricant on | Evaluation of | Evaluation of | Evaluation of |
| | | Protec- | | Thick- | number of | | | blade after | image after | image after | image after |
| | Photo- | tive | | ness of | fibers per | | Linear | 50,000 sheets | 5,000 sheets | 10,000 sheets | 50,000 sheets |
| | con- | agent | Brush | fiber | square | Pressure | velocity | were printed | were printed | were printed | were printed |
| | ductor | bar | rollers | (denier) | inch | (N) | (mm/sec) | out | out | out | out |
| Ex. B1 | B1 | — | — | — | — | — | 125 | A | A | A | — |
| Ex. B2 | B2 | B3 | A | 5.3 | 50,000 | 2.8 | 125 | A | A | B | — |
| Ex. B3 | B3 | B1 | C | 10 | 50,000 | 5 | 125 | A | A | A | — |
| Ex. B4 | B4 | B4 | B | 20 | 50,000 | 3.2 | 125 | A | A | A | — |
| Ex. B5 | B5 | B2 | C | 10 | 50,000 | 6 | 125 | A | A | B | B |
| Ex. B6 | B6 | B5 | C | 10 | 50,000 | 4 | 125 | A | B | B | B |
| Ex. B7 | B10 | B1 | B | 20 | 50,000 | 6.5 | 125 | A | A | A | — |
| Ex. B8 | B11 | B1 | C | 10 | 50,000 | 5 | 125 | A | A | A | — |
| Ex. B9 | B12 | B1 | C | 10 | 50,000 | 6.5 | 125 | A | A | A | — |
| Ex. B10 | B13 | — | — | — | — | — | 125 | A | A | A | — |
| Comp. | B7 | B1 | B | 20 | 50,000 | 3.2 | 125 | NA | B | B | C |
| Ex. B1 | | | | | | | | | | | |
| Comp. | B8 | — | — | — | — | — | 125 | B (IR spectrum) | C | C | — |
| Ex. B2 | | | | | | | | | | | |
| Comp. | B9 | B1 | A | 5.3 | 50,000 | 4 | 125 | B (IR spectrum) | B | C | — |
| Ex. B3 | | | | | | | | | | | |

—Evaluation Criteria of the Presence or Absence of the Lubricant on the Blade after 5,000 Sheets were Printed Out—

A: Boron nitride or metal soap or PMMA was present.

B: Boron nitride or metal soap or PMMA was not present, or a quantitative amount thereof was equal to or lower than the limit of determination.

### —Evaluation Criteria of Image—

A: High quality image

B: Poor image quality was slightly observed with the microscope although it could not be confirmed by visual observation (No problem in practical use).

C: Abnormal image

What is claimed is:

1. A protective sheet comprising:
a lubricant which contains boron nitride and adheres to the protective sheet,
wherein the protective sheet is used to protect a photoconductor.

2. The protective sheet according to claim 1, wherein the lubricant further contains a metal soap.

3. The protective sheet according to claim 2, wherein a mass ratio of the boron nitride is 10% by mass or more, relative to a total mass of the boron nitride and the metal soap contained in the lubricant.

4. An image forming method, comprising:
removing a protective sheet from a photoconductor;
charging the photoconductor, from which the protective sheet has been removed;
exposing the charged photoconductor to laser beam so as to form a latent electrostatic image;
developing the latent electrostatic image formed on the photoconductor using a developer containing a toner, so as to form a toner image;
transferring the toner image from the photoconductor to a transfer medium; and
cleaning the photoconductor, from which the toner image has been transferred, using a cleaning blade,
wherein the protective sheet comprises a lubricant which contains boron nitride and adheres to the protective sheet, and
wherein the protective sheet is used to protect the photoconductor.

5. The image forming method according to claim 4, wherein the cleaning is performed by bringing the cleaning blade into contact with the photoconductor by a counter system.

6. The image forming method according to claim 4, wherein the cleaning blade has a tip which is brought into contact with the photoconductor, and the tip is in the shape of an obtuse angle.

7. The image forming method according to claim 4, further comprising supplying the cleaned photoconductor with a protective agent containing a metal soap.

8. The image forming method according to claim 7, wherein the protective agent further contains boron nitride, and a mass ratio of the boron nitride is 30% by mass or less, relative to a total mass of the boron nitride and the metal soap contained in the protective agent.

9. An image forming apparatus comprising:
a photoconductor;
a charging unit configured to charge a surface of the photoconductor;
a latent electrostatic image forming unit configured to form a latent electrostatic image on the charged surface of the photoconductor;
a developing unit configured to develop the latent electrostatic image on the surface of the photoconductor using a developer containing a toner so as to form a toner image;
a transferring unit configured to transfer the toner image from the surface of the photoconductor to a transfer medium; and
a cleaning unit configured to remove the toner remaining on the surface of the photoconductor, from which the toner image has been transferred,
wherein the photoconductor has a lubricant containing boron nitride adhered to the surface thereof, and the lubricant is applied to the surface of the photoconductor by covering the photoconductor with a protective sheet so that a surface of the protective sheet having the lubricant adhered thereto faces the photoconductor, and removing the protective sheet from the photoconductor.

10. The image forming apparatus according to claim 9, wherein the lubricant is a mixture of a metal soap and the boron nitride.

11. The image forming apparatus according to claim 10, wherein a mass ratio of the boron nitride is 10% by mass or more, relative to a total mass of the metal soap and the boron nitride contained in the lubricant.

12. The image forming apparatus according to claim 9, further comprising a protective agent application unit configured to apply a metal soap as a protective agent to the photoconductor.

13. The image forming apparatus according to claim 12, wherein the protective agent further contains boron nitride, and a mass ratio of the boron nitride is 30% by mass or less, relative to a total mass of the metal soap and the boron nitride contained in the protective agent.

14. The image forming apparatus according to claim 12, further comprising a blade as a protective agent layer thinning unit, in addition to the cleaning unit.

15. The image forming apparatus according to claim 14, wherein the boron nitride or a mixture of the metal soap and the boron nitride adheres to the blade as the protective agent layer thinning unit before the blade is started to use.

16. The image forming apparatus according to claim 14, wherein the blade as the protective agent layer thinning unit is brought into contact with the photoconductor at an angle for use in a counter system.

17. The image forming apparatus according to claim 14, wherein the blade as the protective agent layer thinning unit has a tip which is brought into contact with the photoconductor, and the tip is in the shape of an obtuse angle.
